(19) United States
(12) Patent Application Publication
(10) Pub. No.: US 2014/0026335 A1
(43) Pub. Date: Jan. 30, 2014

(54) SYSTEM AND METHOD FOR BRIDGE REPLACEMENT

(71) Applicant: Thomas Alan Smith, Columbia, MO (US)

(72) Inventor: Thomas Alan Smith, Columbia, MO (US)

(73) Assignee: OCCI, INC., Fulton, MO (US)

(21) Appl. No.: 13/560,950

(22) Filed: Jul. 27, 2012

(51) Int. Cl. E01D 19/02; B61D 17/00; B60P 1/54; E02D 13/10

(52) U.S. Cl. 14/77.3; 405/232; 105/379; 414/813

(57) ABSTRACT

A method and apparatus for placing a pile and a pile cap includes a platform having a set of rail wheels, a tower having pairs of opposed arms which are configured to support a hoisting cable and rotatably mounted with respect to the platform. The apparatus may further include outriggers slidably mounted on opposite sides along the longitudinal axis of the platform, ground wheels oriented such that the axes of rotation are substantially parallel to the longitudinal axis of the platform, and a rotating cutting blade movably mounted to the platform proximate the tower. The apparatus also includes a platform having a set of rail wheels, a tower with an arm having a slidably mounted hoisting cable and a slidably mounted counterweight, and a positioning mechanism to selectively position the counterweight along the arm.

### BACKGROUND OF THE INVENTION

1. Field of the Invention

The present invention relates generally to a system and method for replacing existing support members of bridges which carry railroad or other types of traffic with minimal interruption to traffic flow or the use of temporary support structures.

2. Description of the Related Art

Typical railroad or other type bridge construction often involves the use of wooden, steel, or concrete bridge girders or spans, which are oriented in the general direction of the axis of the railroad or road which is supported by the bridge. The bridge spans are typically supported at intervals by a horizontal cap, which in turn is supported by two or more vertical or battered (inclined) piles, which provide support into the earth for the bridge and the applied load. The existing bridge framework often comprises horizontal or diagonal cross members to brace the piles, and resist lateral forces such as wind, seismic, or live loads. Conventional methods for replacing existing deteriorated, damaged, overloaded or otherwise unsuitable structural members of bridges require long-term interruption of rail traffic flow and off-track equipment with costly access roads.

### SUMMARY OF THE INVENTION

The system and method of the present invention preferably comprises installing new precast concrete piles or large pipe piles outside (wider than) the existing deteriorated timber railroad bridges utilizing the existing railway to access the work area. This is accomplished by mounting necessary construction equipment, materials, and machinery to a mobile carrier (referred to herein as a “rail car”) with capability to travel on a railroad track during construction operations, and preferably on an improved surface near a railroad crossing after construction to allow rail traffic to resume. The system and method of the present invention also preferably comprises using a rail car to install new pile caps on the new piles to provide support for new bridge spans. The system and method of the present invention also preferably comprises using a rail car mounted crane to install new bridge spans on which rail traffic will travel.

### BRIEF DESCRIPTION OF THE DRAWINGS

FIG. 1 is a cross-sectional view of typical timber railroad bridge.

FIG. 2 is an overhead (plan) view of one embodiment of the present invention illustrating the new support pile in place.

FIG. 3 is a side (elevation) view of one embodiment of the present invention with the new support pile in place.

FIG. 4 is a cross-sectional view of one embodiment of the present invention illustrating the installation of a pile.

FIG. 5 is a side view of one embodiment of the present invention with the vertical tower in the horizontal stowed position during travel.

FIG. 6 is a side view of one embodiment of the present invention with the vertical tower in the horizontal stowed position with car located in position for installation of a new pile.

FIG. 7 is a side view of one embodiment of the present invention with the forward outrigger positioned in place over a new pier cap.

FIG. 8 is a side view of one embodiment of the present invention with the vertical tower being erected into the vertical position.

FIG. 9 is a side view of one embodiment of the present invention with the vertical tower in the upright position with telescoping sections in the stowed position.

FIG. 10 is a side view of one embodiment of the present invention with the vertical tower in the upright position with the telescoping sections extended.

FIG. 11 is a side view of one embodiment of the present invention with the vertical tower in the upright position with the tower arms and kingpost extended.

FIG. 12 is a side view of one embodiment of the present invention with the pile hammers being hoisted from the stowed position.

FIG. 13 is a side view of one embodiment of the present invention with the pile hammers shown in the raised position.

FIG. 14 is a side view of one embodiment of the present invention with the tower rotated in the pile driving orientation.

FIG. 15 is a side view of one embodiment of the present invention with the new pile being positioned for lifting.

FIG. 16 is a side view of one embodiment of the present invention with the new piles being connected to the hoist lines for lifting.

FIG. 17 is a side view of one embodiment of the present invention with the new piles hoisted into the vertical position.

FIG. 18 is a side view of one embodiment of the present invention with the vertical tower rotated to the pile installation orientation to install the piles.

FIG. 19 is a side view of one embodiment of the present invention with the new pile set in place for driving.

FIG. 20 is a side view of one embodiment of the present invention with the new pile being held in position using the pile positioning arms and the vertical tower rotated to pile driving orientation.

FIG. 21 is a side view of one embodiment of the present invention with the new pile driven and the vertical tower rotated to the pile installation orientation to place the hoist line above the new pile.

FIG. 22 is a side view of one embodiment of the present invention with the hoist line attached to the driven pile to remove the cut off portion and the pile cutoff saws in operation.

FIG. 23 is a side view of one embodiment of the present invention with the hoist line lifting the pile cut portion.

FIG. 24 is a side view of one embodiment of the present invention with the car repositioned with the forward and aft outriggers located over the new pile.

FIG. 25 is a side view of one embodiment of the present invention with the aft and forward outriggers placed on the new pile.

FIG. 26 is a side view of one embodiment of the present invention with the aft outrigger positioned over a pile and the forward outrigger positioned over a second pile.

FIG. 27 is a side view of one embodiment of the present invention with the forward outrigger placed on the new pile and the aft outrigger in the retracted position.

FIG. 28 is a side view of one embodiment of the present invention with the car repositioned for installation of the next pile while being stabilized by the forward outrigger.

FIG. 29 is an overhead (plan) view of one embodiment of the present invention showing the pile positioning arms in place with the new pile.

FIG. 30 is an end view of one embodiment of the present invention showing the pile positioning arms in place with the new pile.

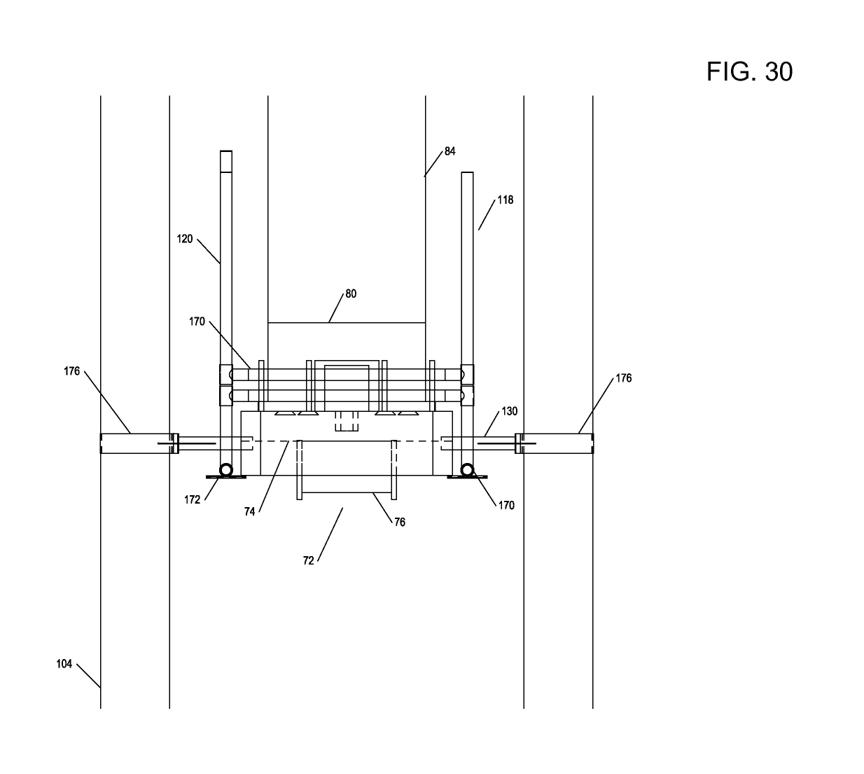

FIG. 31 is an overhead (plan) view of one embodiment of the present invention illustrating the staging area where the rail car may be removed from the rails.

FIG. 32 is an overhead (plan) view of one embodiment of the present invention illustrating the pile cap rail car during travel.

FIG. 33 is an overhead (plan) view of one embodiment of the present invention illustrating the pile cap rail car with the trolley located above the new cap.

FIG. 34 is an overhead (plan) view of one embodiment of the present invention illustrating the pile cap rail car with the sliding counterweight positioned to lift the new cap.

FIG. 35 is an overhead (plan) view of one embodiment of the present invention illustrating the pile cap rail car with new pile cap lifted and the tower rotating to position the new cap for installation.

FIG. 36 is an overhead (plan) view of one embodiment of the present invention illustrating the pile cap rail car with new pile cap lifted and the tower rotating to position the new cap for installation.

FIG. 37 is an overhead (plan) view of one embodiment of the present invention illustrating the pile cap rail car with new pile cap lifted and the tower rotating to position the new cap for installation.

FIG. 38 is an overhead (plan) view of one embodiment of the present invention illustrating the pile cap rail car with the new pile cap positioned on the new piles.

FIG. 39 is an overhead (plan) view of one embodiment of the present invention illustrating the pile cap rail car with the sliding counterweight repositioned following setting of the new pile cap on the piles.

FIG. 40 is an overhead (plan) view of one embodiment of the present invention illustrating the pile cap rail car in travel position.

FIG. 41 is an overhead (plan) view of one embodiment of the present invention illustrating the pile cap rail car with boom orientated parallel with the rail in travel position and trolley positioned over new pile cap.

FIG. 42 is a side view of the cap rail car illustrating the storage position of the new pile caps.

FIG. 43 is a side view of the picking frame with the pile cap in place.

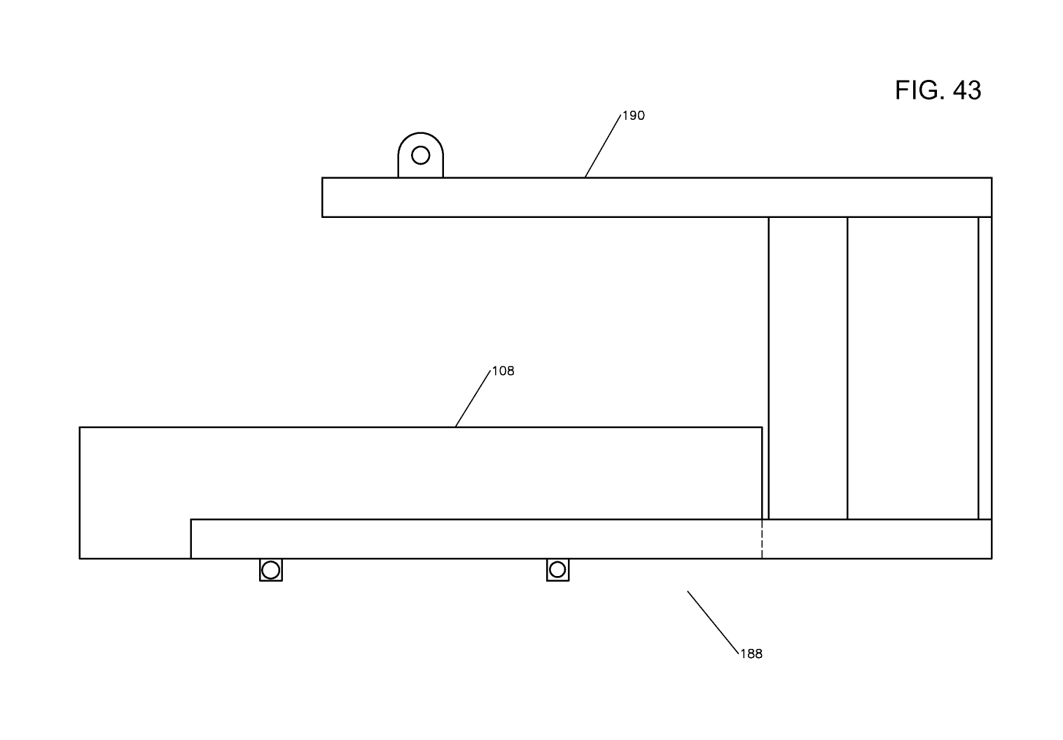

FIG. 44 is an overhead (plan) view of the picking frame with the pile cap in place.

FIG. 45 is a side (elevation view) of one embodiment of the present invention illustrating the cap to pile connection.

FIG. 46 is an overhead (plan) view of the cap rail car illustrating the tower boom with the sliding counterweight and trolley positioned to hoist the first segment of a new bridge span.

FIG. 47 is an overhead (plan) view of the cap rail car illustrating the boom rotating to position the first segment of a new bridge span.

FIG. 48 is an overhead (plan) view of the cap rail car illustrating the boom setting the first segment of a new bridge span.

FIG. 49 is an overhead (plan) view of the cap rail car illustrating the boom hoisting the second segment of a new bridge span.

FIG. 50 is an overhead (plan) view of the cap rail car illustrating the boom setting the second segment of a new bridge span.

FIG. 51 is an overhead (plan) view of the pile transport car with hinged side walls in open position and pile positioned for transfer to the rail car.

FIG. 52 is a cross-section view of the pile transport car with the side walls in closed position and pile stowed for travel.

FIG. 53 is a cross-section view of the pile transport car with the side walls in the open position and pile positioned for transfer to the rail car.

FIG. 54 is a side view of the pile transport car with the side walls in the closed position and the pile stowed for transportation.

### DETAILED DESCRIPTION OF THE INVENTION EXISTING RAILROAD BRIDGE

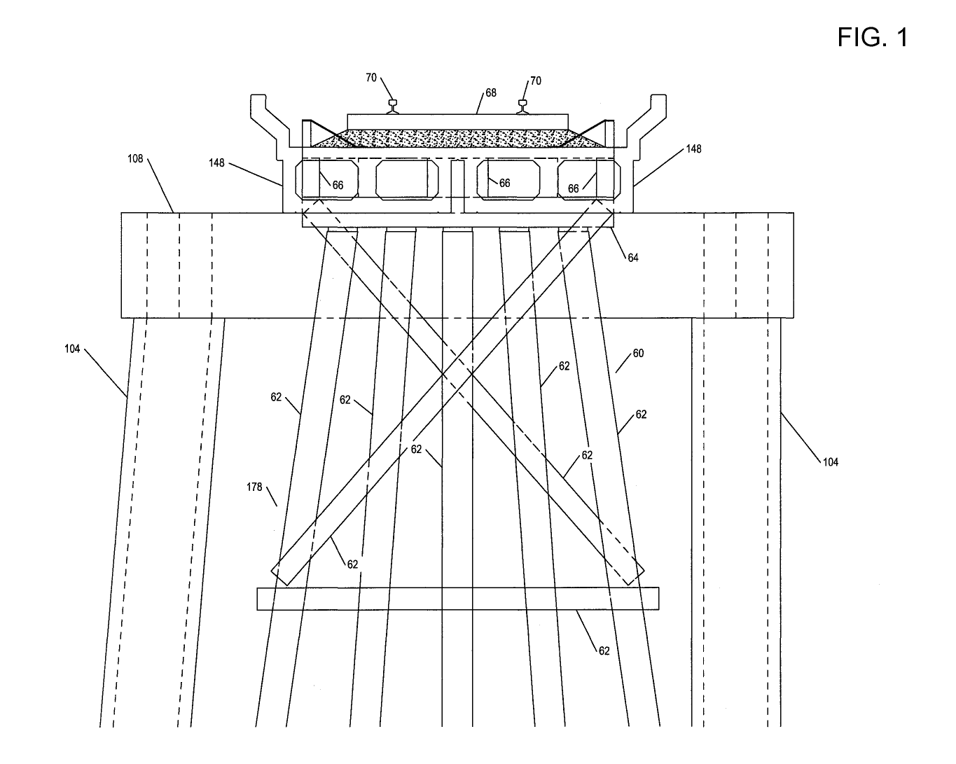

As illustrated in FIG. 1, a typical railroad or other type bridge construction involves the use of a series of bridge girders or spans 66, which are oriented in the general direction of the longitudinal axis of the railroad or road which is supported by the bridge 60. The bridge spans 66 provide the support for the railroad ties 68 and the rails 70 upon which the rail traffic is provided. The bridge spans 66 are typically supported at each end by a pier or bent 178 which provides support into the earth for the bridge and the applied load. The bridge piers 178 are generally constructed of wood timbers or other materials, often comprising one or more drilled shaft columns or column-like piles 62 which are driven into the soil for support at the lower portion. The piles 62 are connected at their topmost ends by a cap 64, strut, or other member to distribute the applied load among the support piles or shafts 62. The pier cap 64 will often have an elongated rectangular footprint with the long axis of the footprint oriented transverse to the longitudinal axis of the bridge spans 66. When a bridge pier 178 or span 66 becomes deteriorated, damaged or is otherwise unserviceable, in order to maintain the integrity and use of the bridge structure, it is desirable to provide a replacement support structure with minimal interruption of the use of the bridge structure.

The present invention involves an innovative method and apparatus comprising the use of a rail car which is preferably designed to be mounted on and dismounted from the existing track from any at-grade pavement or other suitable surface located adjacent to the tracks by use of wheels, legs or other components. This configuration allows the rail car to selectively be located to a surface off the track to allow rail traffic to proceed, or mounted on the rails 70 for access to existing bridge locations to conduct repair and replacement operations.

### Rail Car

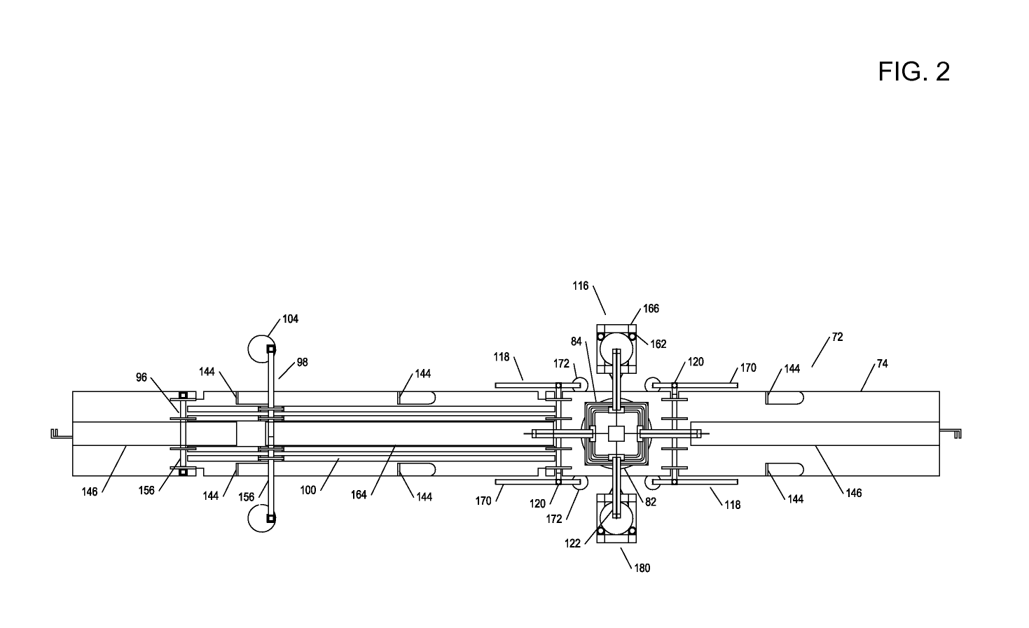

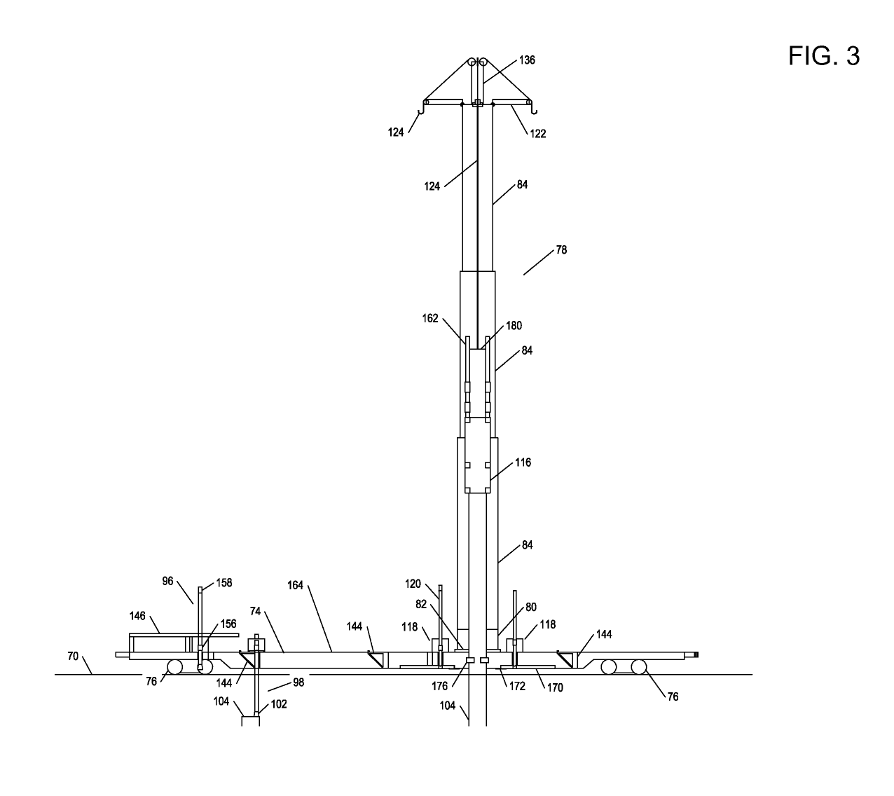

As shown in FIGS. 2 and 3, the rail car 72 comprises a substantially flat bed or platform 74 which is supported by wheels 76 on the existing rails 70. The rail car also comprises a vertical tower assembly 78 which preferably comprises two pairs of opposing tower arms 122, each arm equipped with a hoisting cable 124 for lifting a new pile 104 or a pile hammer 116. In each pair of opposing tower arms 122, the arms are located at polar opposite sides of the tower to provide a counterbalancing effect when simultaneously lifting pairs of new piles 104 of similar sizes and weights, or pairs of identical pile hammers 116. The pairs of tower arms 122 are preferably located on axes perpendicular to one another, such that the four tower arms 122 are oriented in 90 degree relationship to one another.

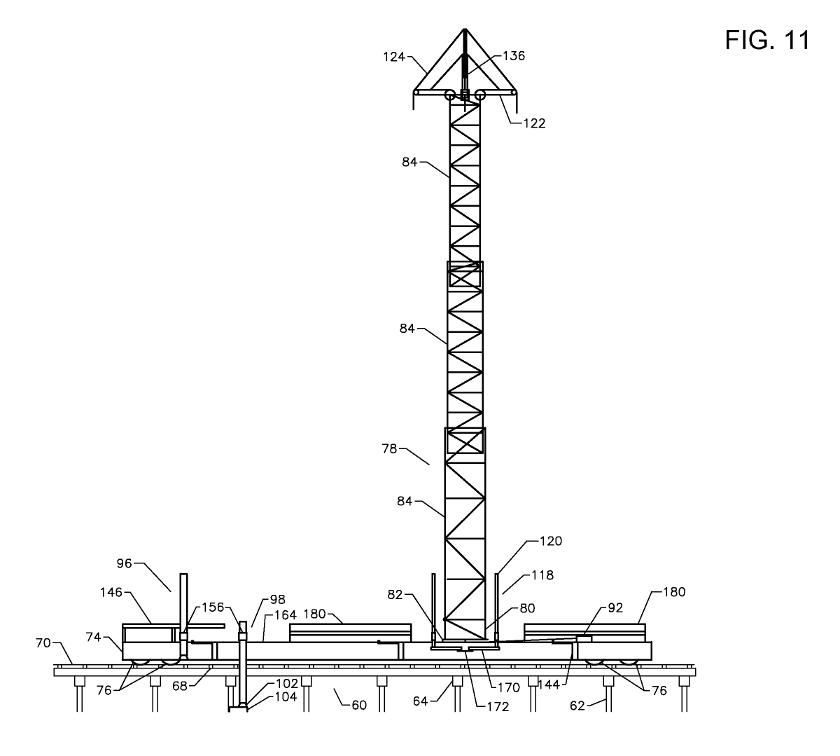

With the tower assembly in the vertical position, the tower arms 122 can be extended into position using a cable winch, hydraulic actuator, or other suitable mechanism to provide sufficient lateral offset distance from the tower for the new piles 104 so that they are outside the existing railroad bridge piles 62. The tower arms 122 are preferably hingedly mounted to the tower 78 and can be extended into position using a kingpost 136 extending above the upper telescoping tower section 84 with guy wires supporting the tower arms 122. Alternatively, the tower arms 122 can be locked into the horizontal position by an angle brace supported by the upper telescoping tower section 84, or the kingpost 136 extending above the upper telescoping tower section 84 with guy wires supporting the tower arms 122 as shown in FIG. 11, or a structural beam that extends across and interlocks with opposing pairs of arms 122. Each tower arm 122 is equipped with a hoisting cable 124 having an end fitting that is configured to be secured to a new pile 104 or a pile hammer 116.

### Tower Orientations

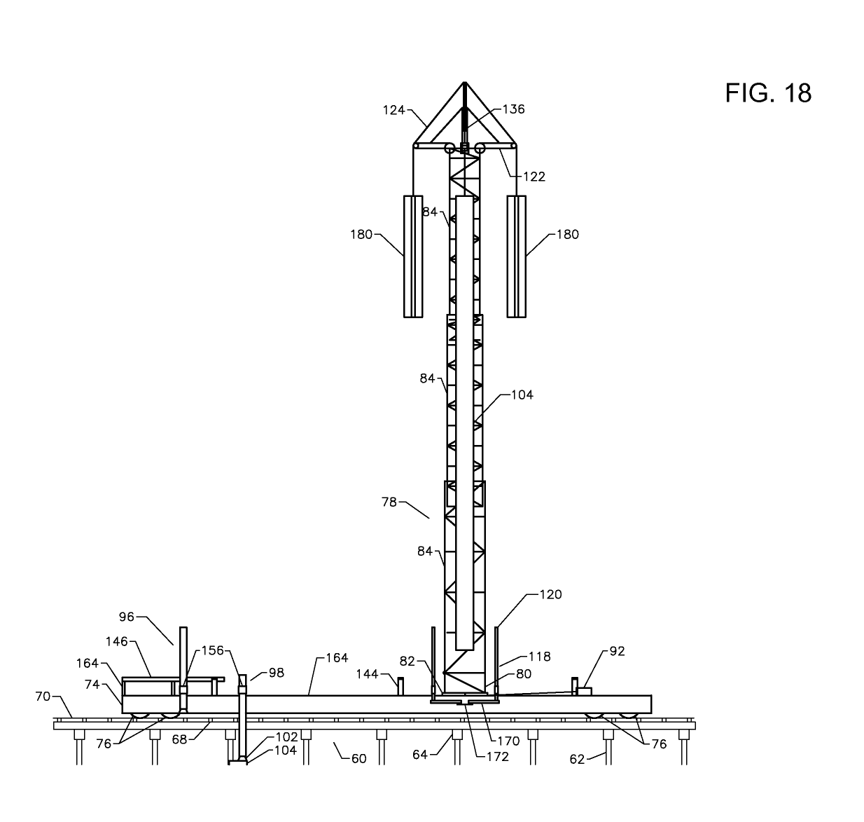

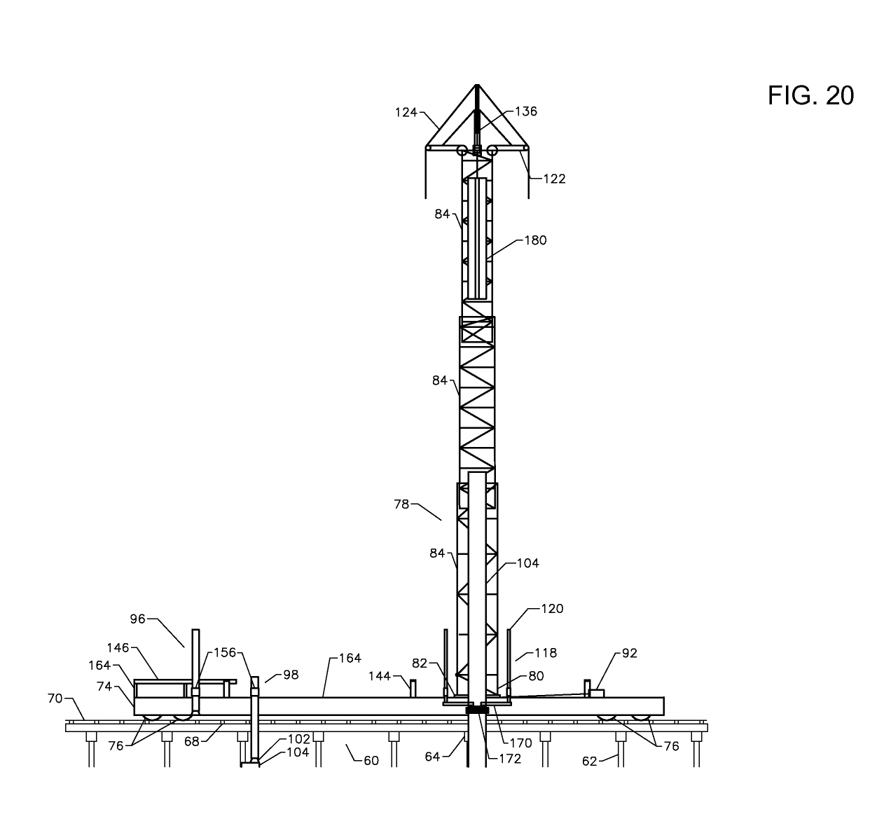

As shown in FIGS. 2, 3 and 4, the tower 78 is preferably mounted on a rotating base 80 by use of a rotary-bearing 82. The rotating base allows the tower to be rotated at least 90 degrees during operation to shift between two primary orientations for efficient installation of new bridge components. One such orientation is the pile installation orientation (FIG. 18), in which the pair of arms 122 for supporting new piles 104 are oriented transverse to the rail axis such that two new piles 104 are simultaneously suspended laterally outside the rails 70 on opposite sides of the rail car 72 for placement in proper orientation and location in preparation, for driving. The other orientation (FIG. 20) is the pile driving orientation, in which the pair of arms 122 for supporting the two pile hammers 116 are oriented transverse to the rail axis such that the two pile hammers are simultaneously suspended laterally outside the rails 70 on opposite sides of the rail car 72 for positioning on and driving the newly-installed piles 104. The tower 78 can also be positioned at intermediate orientations as appropriate for hoisting pairs of new piles 104 or pairs of pile hammers 116 from their stowed positions on the rail car 72 or other locations.

The rail car 72 is also preferably equipped with pile positioning arms 130 and pile cut off saws 118 proximate the tower 78 on each side of the rail car.

### Outriggers

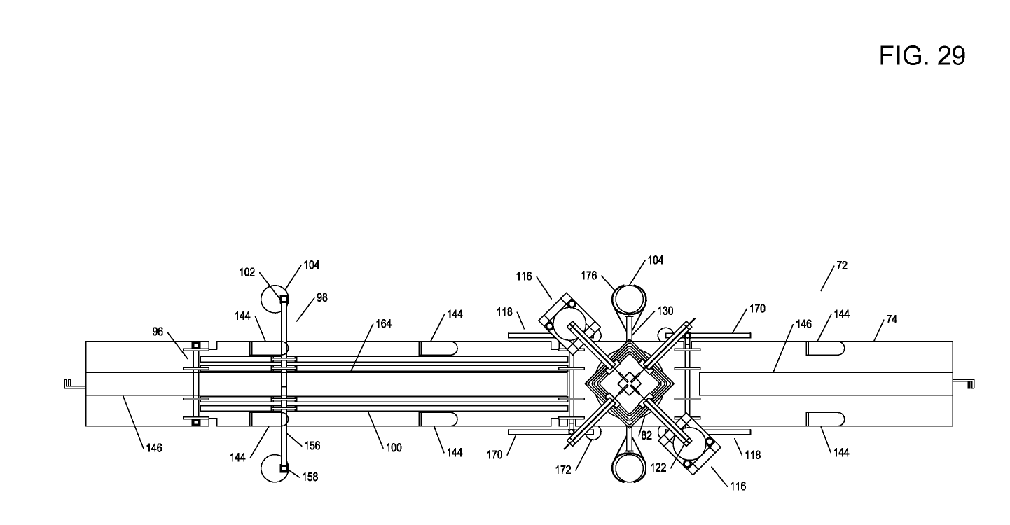

As shown in FIGS. 2, 3 and 4, the rail car 72 is preferably stabilized during construction operations by the use of pairs of aft outriggers 96 and forward outriggers 98 preferably shown installed on the rail car 72 aft of the vertical tower. However, the outriggers may be mounted at any location on the length of the rail car as required to provide stability. The aft and/or forward outriggers may be mounted on a pair of outrigger tracks 100 which extend along a substantial portion of the rail car 72, preferably at least the length of the bridge span. As illustrated in FIG. 29, one or both of the pairs of forward and aft outriggers 96 and 98 may be repositioned along the outrigger tracks 100 by use of various powered means, including electric, hydraulic, pneumatic or other power sources. Each outrigger is configured with an outrigger foot 102 which is configured to provide support when positioned on the upper surface of a newly installed pile 104 along the existing railroad bridge 60 or when extended to any suitable support foundation, including the ground surface beneath the existing bridge.

### Vertical Tower Assembly

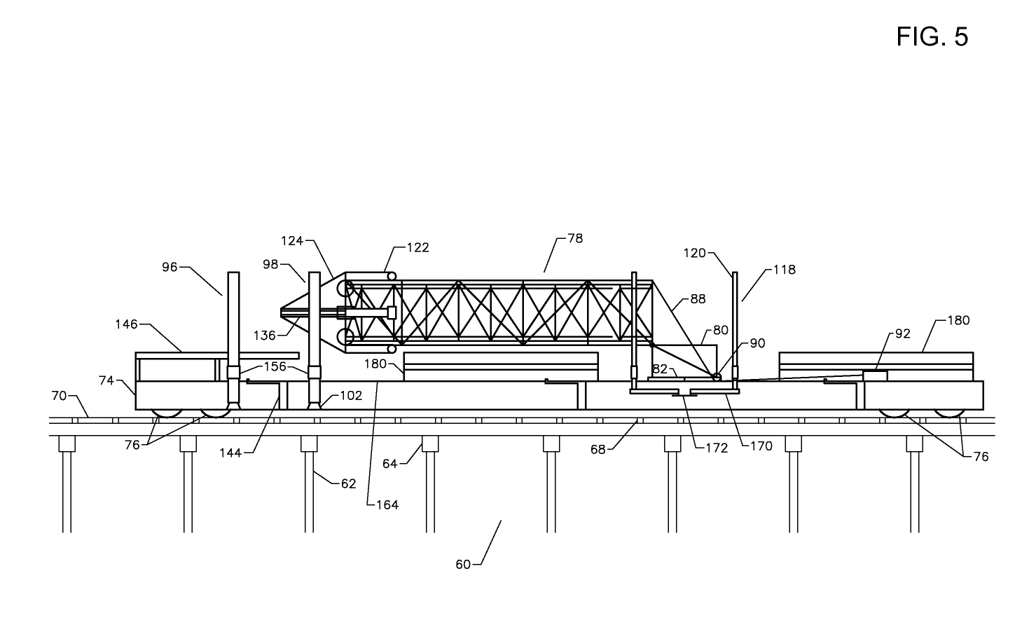

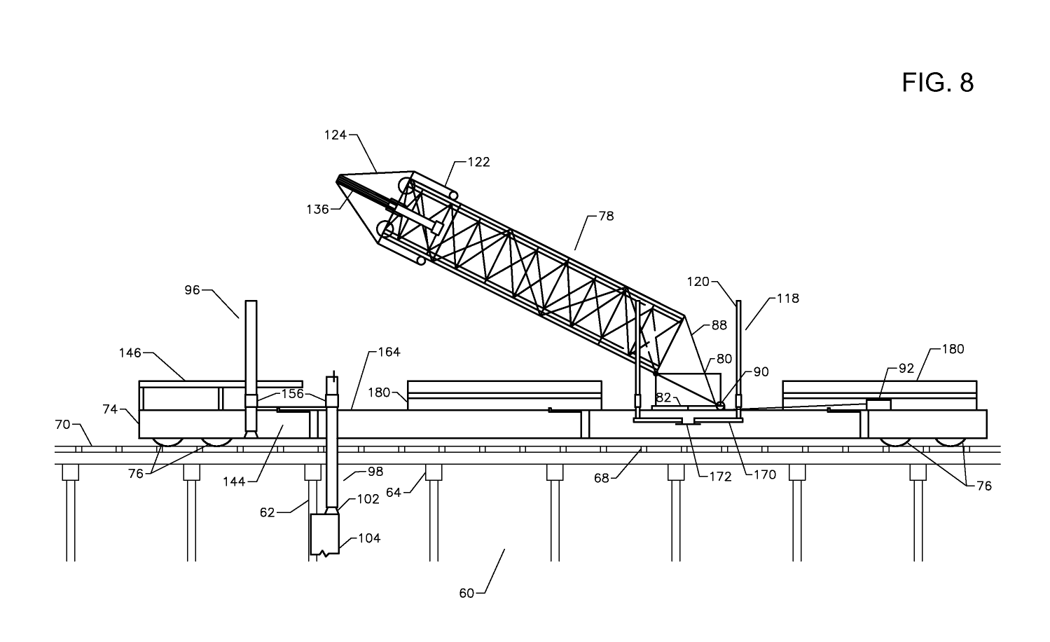

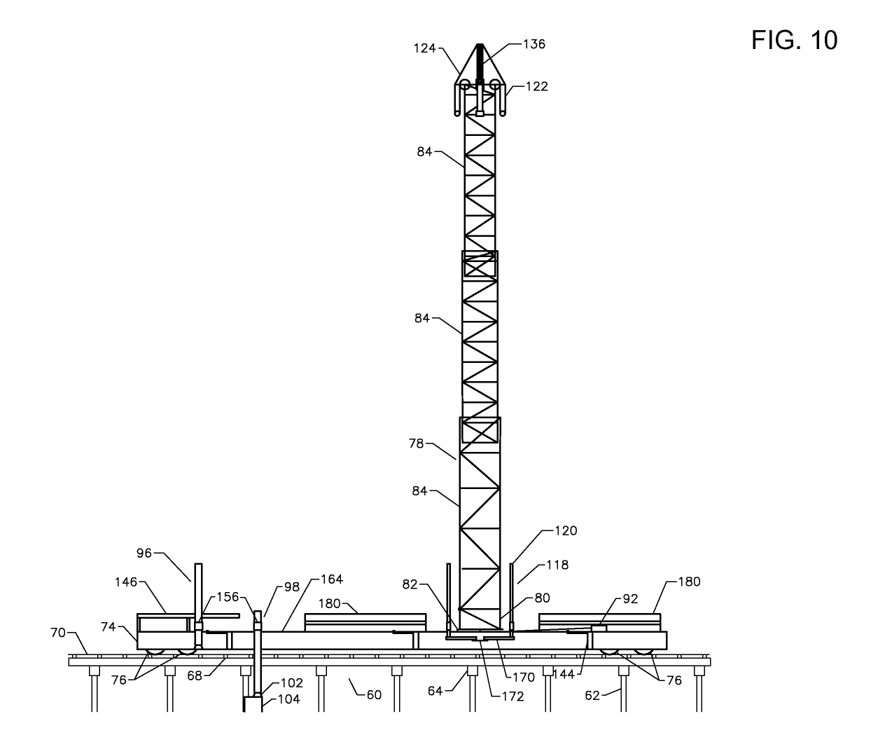

As shown in FIGS. 5-11, the tower assembly 78 preferably includes a plurality of telescopic sections 84 which can be extended from a horizontal stowed position shown in FIG. 5 into a vertical operating position shown in FIG. 10 using an erecting cable system 86 or hydraulic cylinders. This configuration allows the use of a tower with sufficient height in the operating configuration to install reinforced concrete piles or other type of piling of substantial length, while also providing a minimum height in the stowed position to avoid interfering with the ability of the railroad car to be transported by transportation means which have height limitations, such as by truck or rail transportation over highways or rail lines with vertical clearance limitations from bridges, tunnels or overpasses. With the vertical tower stowed, the rail car apparatus will preferably fit within the current American Railway Engineering and Maintenance-of-Way Association (“AREMA”) clearance window. The telescoping vertical tower sections 84 are preferably comprised of braced truss structures to maximize structural integrity, while minimizing weight and allowing access to the tower components for maintenance and repair as necessary. The erecting cable system 86 includes one or more erecting cables 88 which are routed through a plurality of pulleys 90. The cables 88 are driven by the erecting cable winch 92. As understood by those of ordinary skill in the art, the erecting cable winch 92 may be powered by an electric motor, hydraulic cylinder, pneumatic or other power sources which are available at the construction location. Alternatively, a hydraulically actuated cylinder may be used to erect the tower. The vertical tower assembly is rotated using a tower-based drive motor 94 which also may be powered by electric, hydraulic, pneumatic or other power sources which are available at the construction location.

As shown in FIGS. 10 and 11, the tower assembly 78 includes two pairs of opposing tower arms 122 which are preferably hingedly connected to the upper telescoping tower section 84. The tower arms 122 can be locked into the horizontal position by an angle brace supported by the upper telescoping tower section 84, or alternatively a kingpost extending above the upper telescoping tower section 84 with guy wires supporting the tower arms 122, or a beam that extends across and interlocks with opposing pairs of arms 122.

As shown in FIG. 11, each tower arm 122 is equipped with a hosting cable 124 which may be used for lifting and installing piles 104 into position, or alternatively to suspend and position the pile hammer 116.

### Tower Operation

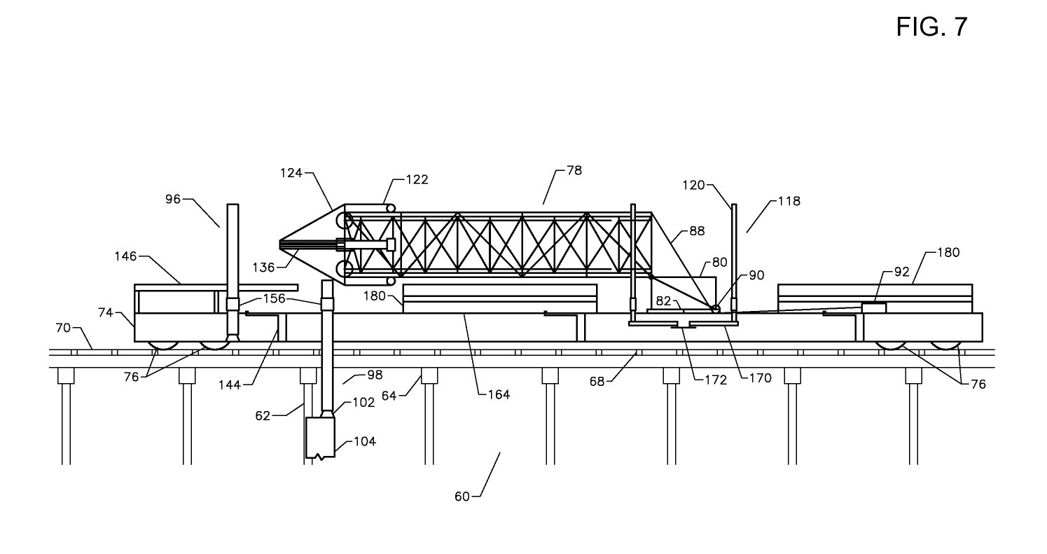

As shown in FIG. 7, as required for site-specific forces, once the rail car 72 is stabilized by the aft and/or forward outriggers 96 and 98, the vertical tower assembly may be raised from its stowed horizontal position along the rail car bed 74 by the erecting cable system 86 or alternatively, by a hydraulically actuated cylinder. As shown in FIG. 5, the vertical tower assembly in its retracted horizontal position is suitable for transportation along routes which have limited vertical clearances, such as highways or railroad tunnels. When erected to the vertical position, the tower assembly can extend to sufficient height to allow the new piles 104 to be lifted from a horizontal position on the rail car or adjacent material transport cars into position for driving.

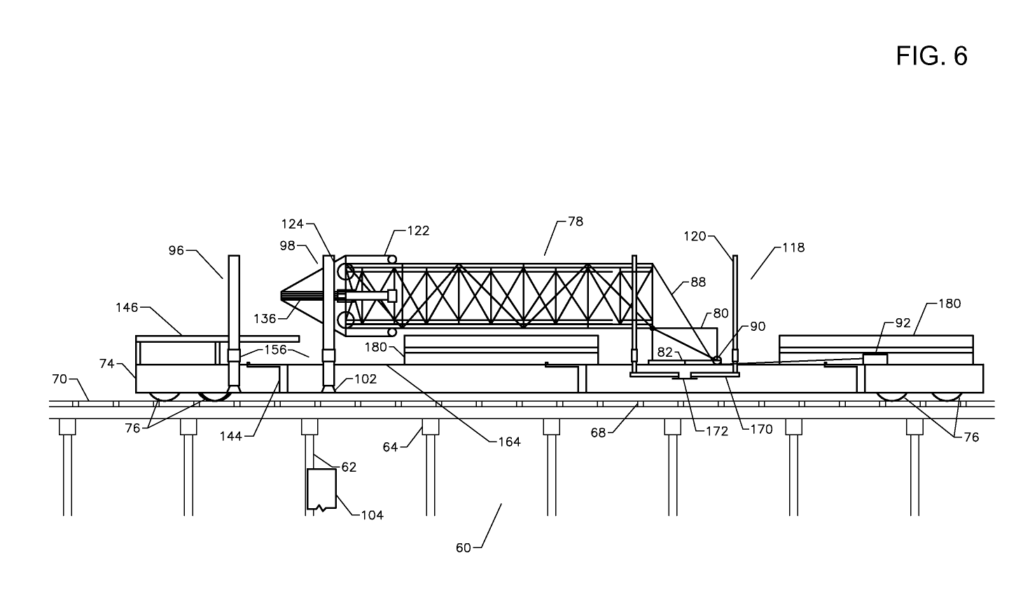

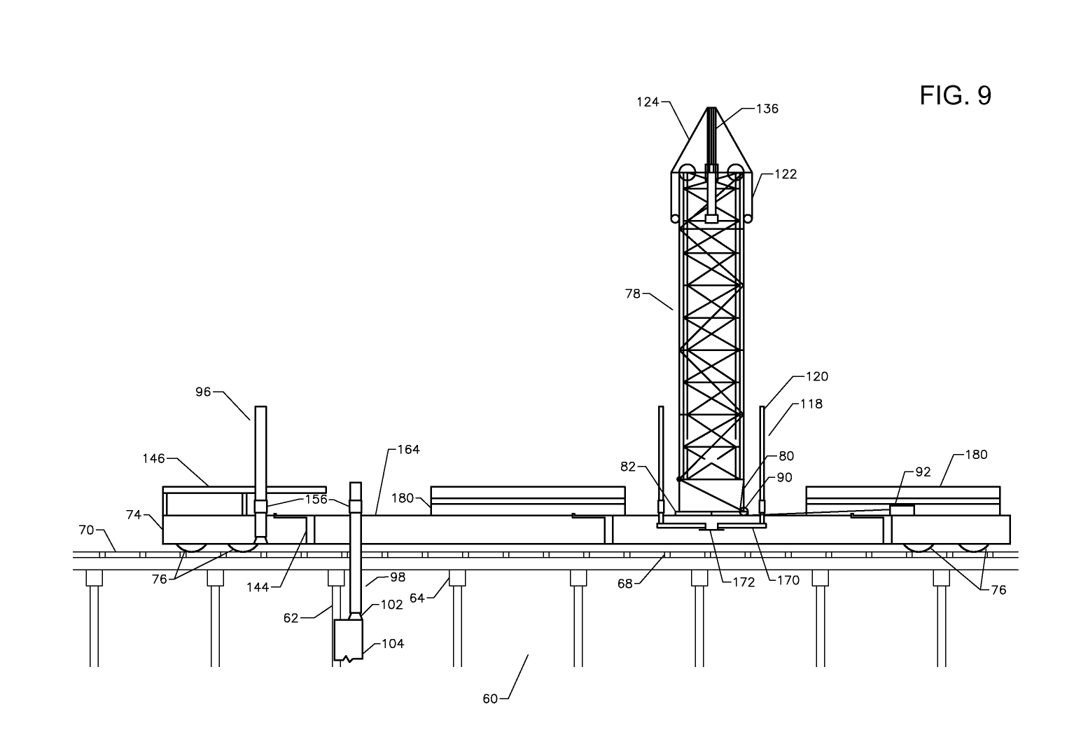

As shown in FIGS. 6-9, the erecting cable motor 92 retracts the erecting cable 88 to lift the tower assembly 78 from a horizontal position to its vertical orientation. As shown in FIG. 9, once the vertical position is established, the tower assembly 78 can be locked in position using a pinning mechanism. Preferably, once the tower assembly is in the erect vertical position, the further retraction of the erecting cable 88 will cause the telescopic sections 84 to extend vertically as shown in FIG. 10. The telescoping sections may be extended using other means, such as hydraulic cylinders, electric motors, or a separate winch.

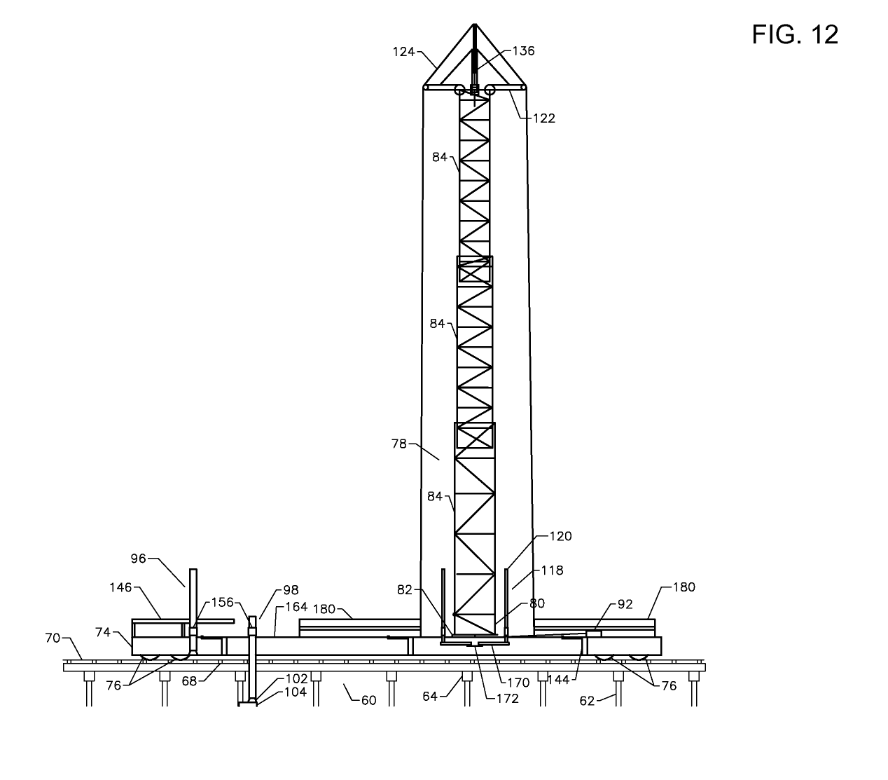

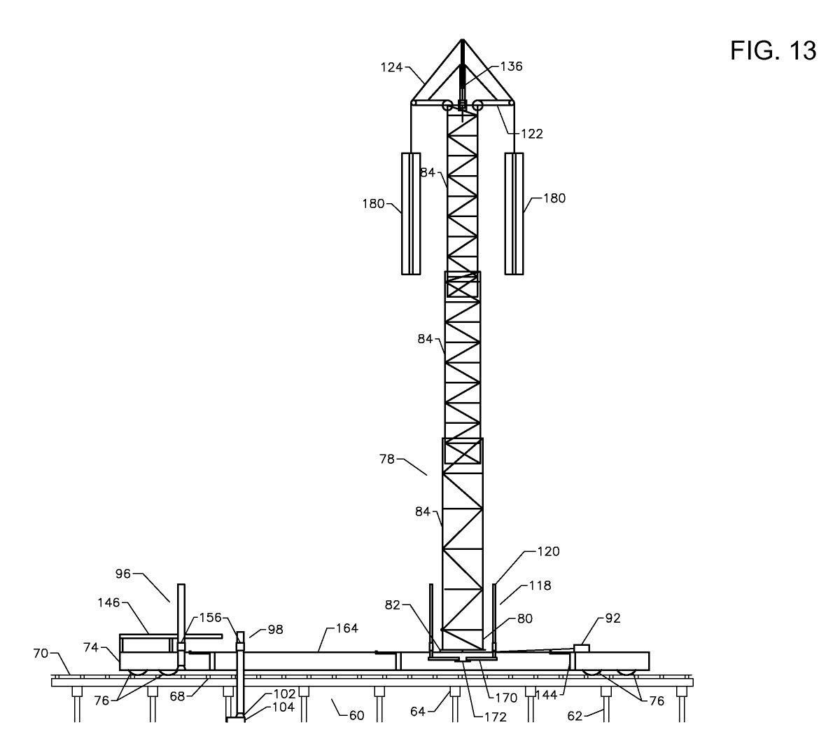

As shown in FIG. 12, once the tower is in the pile installation orientation, in which the pair of opposing tower arms 122, arms for supporting for new piles 104 are oriented transverse to the rail axis, the hoisting cables 124 can be attached to the pile hammers 116 simultaneously from the forward and aft positions on the rail car 72 or adjacent material transport cars, which are also transported on the existing track. As shown in FIGS. 12 and 13, by simultaneously lifting the pile hammers 116 into position on the opposing tower arms 122, the forces necessary to stabilize the tower 78 are minimized.

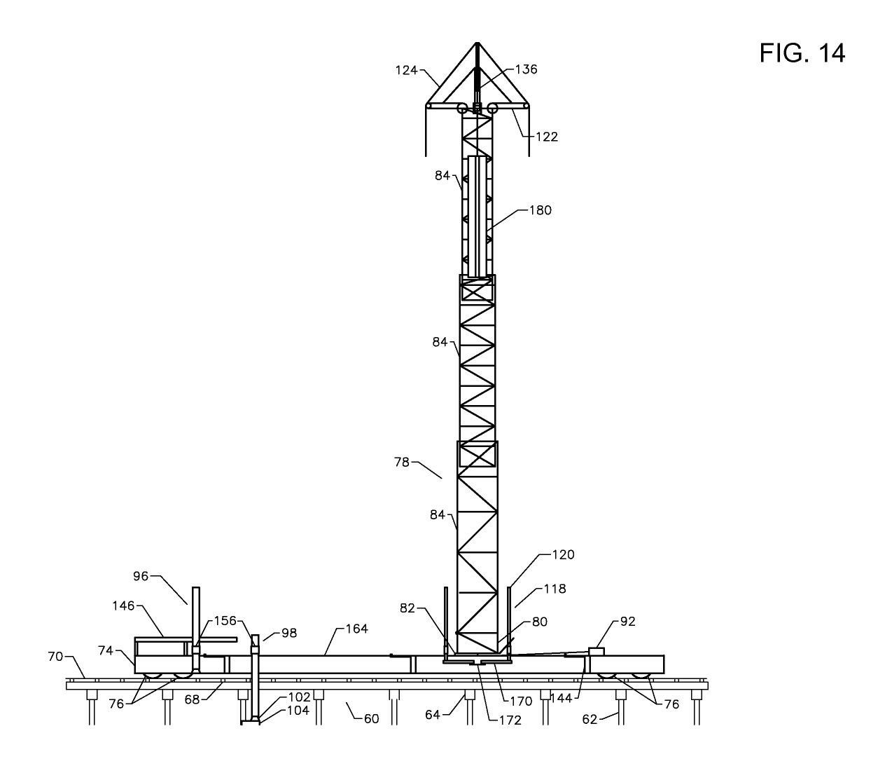

Once the pile hammers 116 are in a fully supported position, as shown in FIG. 13, the vertical tower assembly 78 can be rotated to the pile driving orientation (FIG. 14) on the rotating bearing 82 on the rotating base 80 so that the hoisting cables 124 can be attached to new piles 104 simultaneously from the forward and aft positions on the rail car or adjacent material transport cars, which are also transported on the existing track. The tower 78 can also be positioned at intermediate orientations as appropriate for hoisting pairs of new piles 104 from other stowed positions on the rail car 72 or other locations.

As is known and understood in the art, structural piles are primarily designed to withstand compressive force forces in the loaded condition, and have limited resistance to bending stresses as may be imposed when a pile is lifted is from a horizontal supported position by a hoisting point near either end. Accordingly, to reduce the bending load in a pile that is being hoisted by a cable, the hoisting point is preferably located away from the end of the pile and towards the midpoint of the pile.

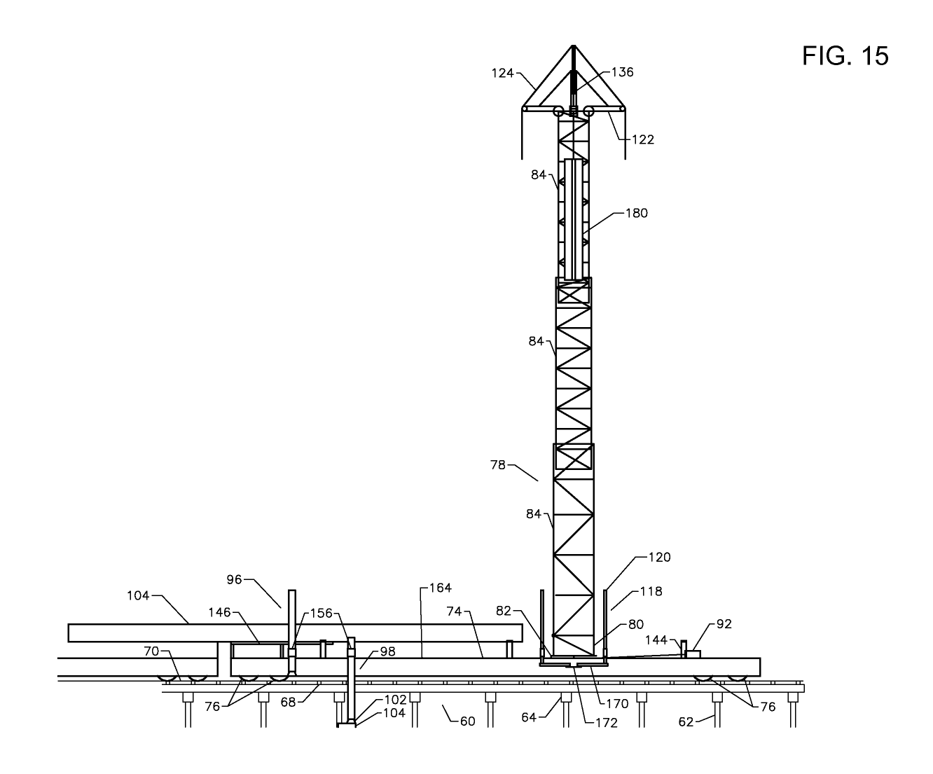

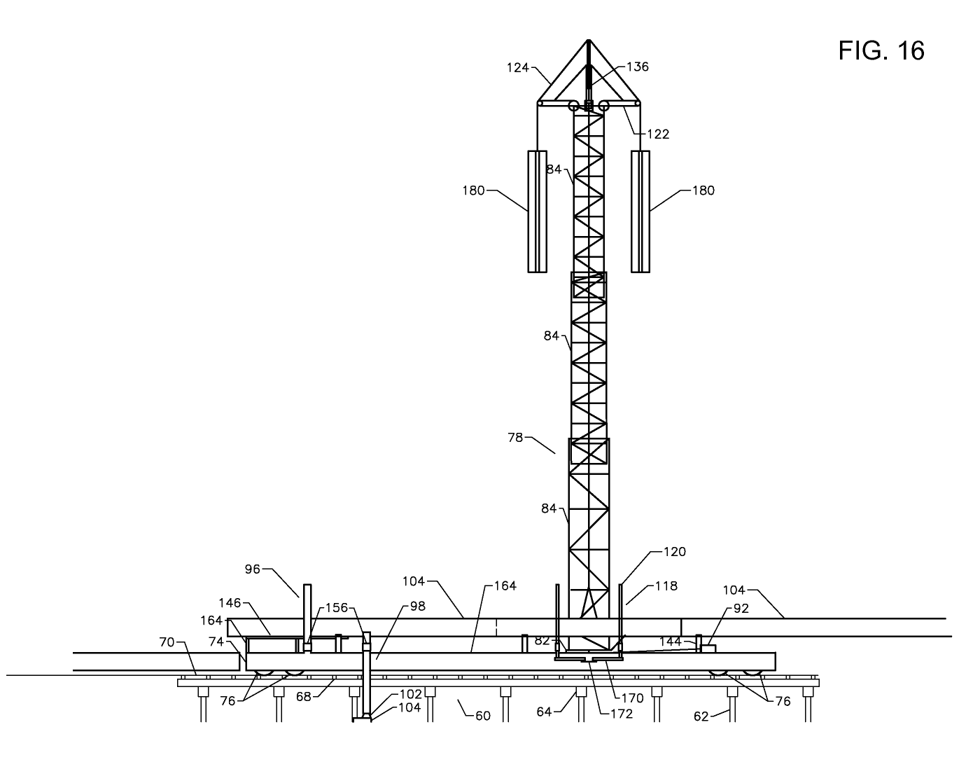

As shown in FIGS. 15-16, the present invention allows the positioning of piles beneath and outboard of the tower 78 so that the hoisting cable may be secured at a point intermediate the end and the midpoint of the pile 104. By supporting the pile with on one or more pile support brackets 144 with rollers or other configurations to allow the pile to slide from an adjoining rail transport car to the platform 74 of the rail car 72, the pile may be positioned so that it may lifted from a hoisting point lower than its end. In this manner, the pile can be lifted with reduced bending stress to prevent structural failure of the pile while it is raised by the hoisting cable and supported at the other end on the platform 74 or adjoining material transport car. As shown in FIG. 16, by having one pile slide onto the platform from each of the forward and aft directions, a balanced loading condition on the tower is created.

As shown in FIG. 29, in order to achieve the appropriate distance of the tower arms 122 outboard of the rail car centerline so that the hoisting cable 124 is at the appropriate outboard distance to line up with the centerline of the piles to be hoisted, the rotating tower may be adjusted to any position to achieve such desired outboard distance for the hoisting cable 124.

As described in more detail below, the pile transport car 156 of the present invention allows the piles 140 to be transported in a position near the centerline of the rails to maximize the stability of the pile transport car 156, and also allows the piles to be positioned outboard from the rail centerline for repositioning onto the rail car 72 for hoisting by the hoisting cable 124 from a position sufficiently outboard from the centerline to avoid interference with the tower 78.

As the pile is offloaded from the pile transport car 156 to the rail car 72, it is rolled from the rollers 196 of the hinged sidewall 192 to the rollers of the pile support brackets 144 on the railcar 72, which are at the same elevation above the rails 70.

As shown in FIG. 16, by simultaneously lifting the piles into position on the opposing tower arms 122, the forces necessary to stabilize the tower are minimized. Once the new piles 104 are in a fully supported position, if necessary, the vertical tower assembly 78 can be rotated on the rotating bearing 82 of the rotating base 80 to the pile installation orientation (FIG. 18), so that the piles 104 can be positioned on either side of the track in sufficient positions for driving into the soil beneath the existing railroad bridge 60.

### Pile Hammer

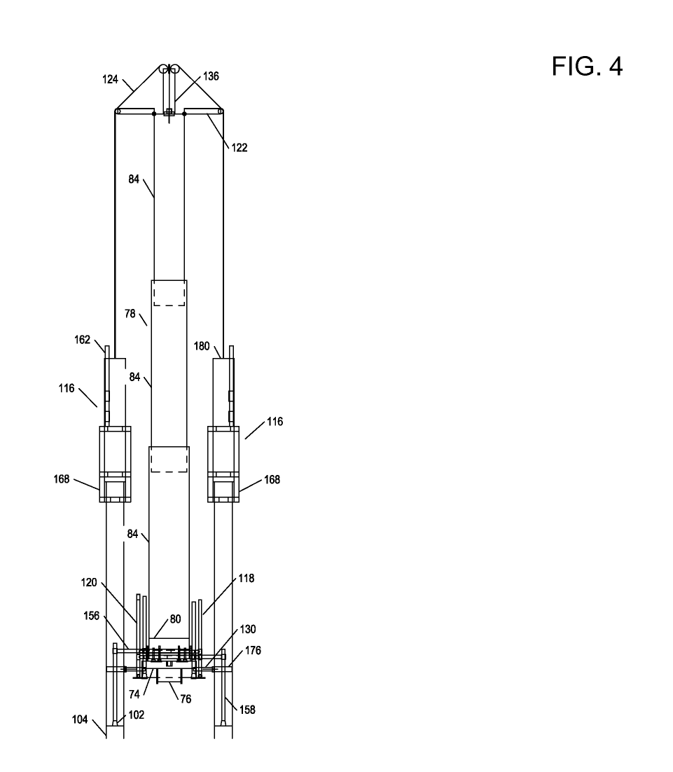

As shown in FIG. 4, the pile hammer assembly 116 comprises the pile hammer 180 and the pile lead 162, which is a frame used to guide and position the pile hammer 180 over the top surface of the new pile 104 to be driven. The pile hammer will preferably be a traditional diesel-powered pile hammer, hydraulic pile hammer, or other type of pile hammer of sufficient size to drive a pile 104 of desired capacity. The lead system 162 will preferably be of the rope-suspended type commonly used in “riding hammer” applications. As shown in FIG. 4, the pile hammer assembly 116 may also comprise a “pile helmet” 168, configured with a concentric flange to fit over the upper portion of the pile 104, to maintain the pile lead 162 in position on the pile 104 during driving. The pile hammer 180 and lead system 162 may be utilized to drive the pile 104 in either a vertical or battered orientation.

### Pile Positioning Arms

As shown in FIG. 29, the pile positioning arms 130 extend from both sides of the rail car to position the pile 104 for proper driving into the soil. The pile positioning arms 130 each have a pile positioning arm clamp 176 which is preferably hingedly connected to the pile positioning arm to allow the clamp to restrain the pile 104 in the proper orientation. The pile positioning arms 130 are preferably offset from one another at slightly different elevations so as to operate in different vertical planes, thus allowing simultaneous retraction of the arms on opposite sides of the car into the rail car.

### Pile Positioning

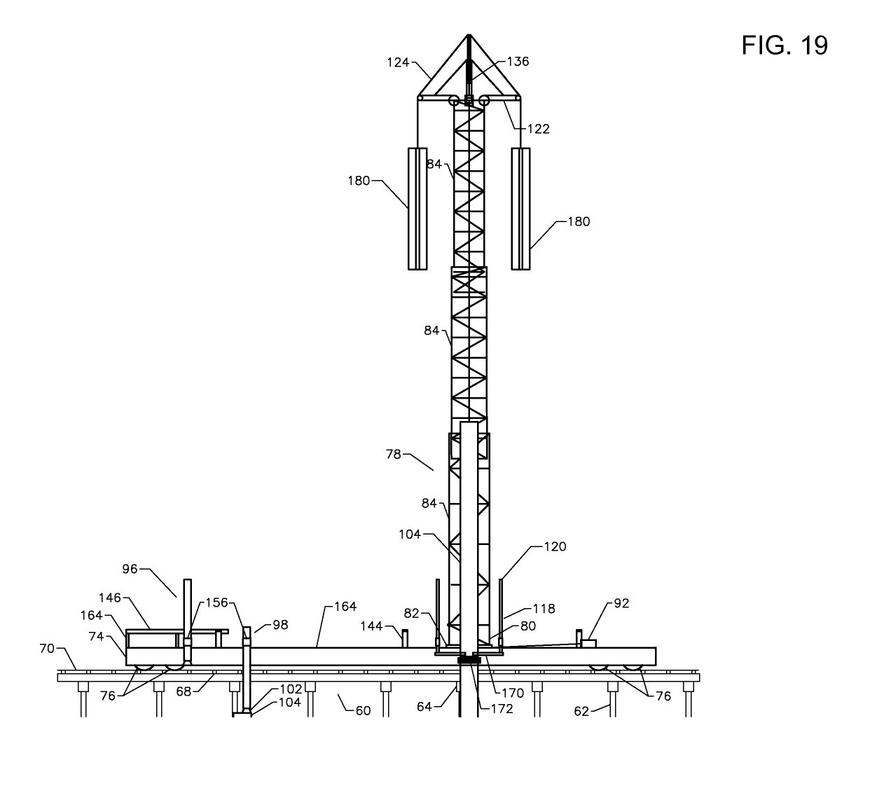

As shown in FIGS. 18 and 19, when the pile is lowered from its position during rotation on the vertical tower 78, as the bottom portion reaches the rail 70 elevation, the pile positioning arm 130 can be extended or retracted to orient the pile as desired. As can be appreciated by a person of ordinary skill and the art, when the bottom portion of the pile 104 approaches the desired insertion point in the soil, the pile can be repositioned laterally from the rail car 72 by extending or retracting the pile positioning arms 130 outward or inward from the rail car 72. Then once the new pile 104 bottom portion makes contact with the desired insertion point in the soil, the pile positioning arms 130 may be adjusted laterally to obtain the desired batter for the pile.

Once the driving operation has been conducted on the pile to the point that the pile hammers are approaching the rail 70 elevation, the pile positioning arms 130 can be retracted into the rail car to avoid interference with the operation of the pile hammer 116.

### Pile Hammer Operation

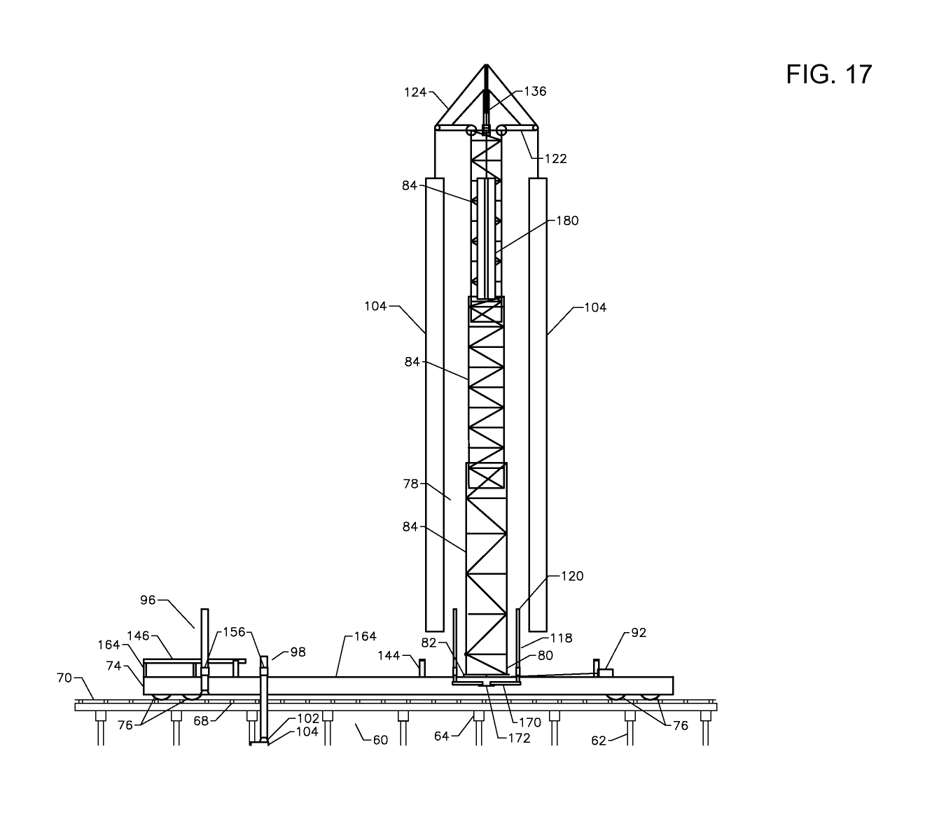

As shown in FIG. 11, the pile hammers 116 are stored in stowage locations forward and aft of the vertical tower on the rail car 72. As shown in FIGS. 12 and 13, the pile hammers 116 are simultaneously hoisted by tower arms 122 on opposite sides of the vertical tower. As shown in FIG. 14, the tower 78 is then rotated to the driving orientation or other appropriate orientation so that the other pair of tower arms 122 (for the pile installation) may be used to raise the new piles 104 from their storage locations on the material transport cars located respectively forward and aft of the rail car 72. Once the piles 104 are hoisted onto the vertical tower 78, as shown in FIG. 17, the tower can again be rotated to the pile installation orientation (FIG. 18) and the piles 104 can then be lowered into a desired position for driving with the use of the pile positioning arms 130, as shown in FIG. 19.

### Cutoff Saws

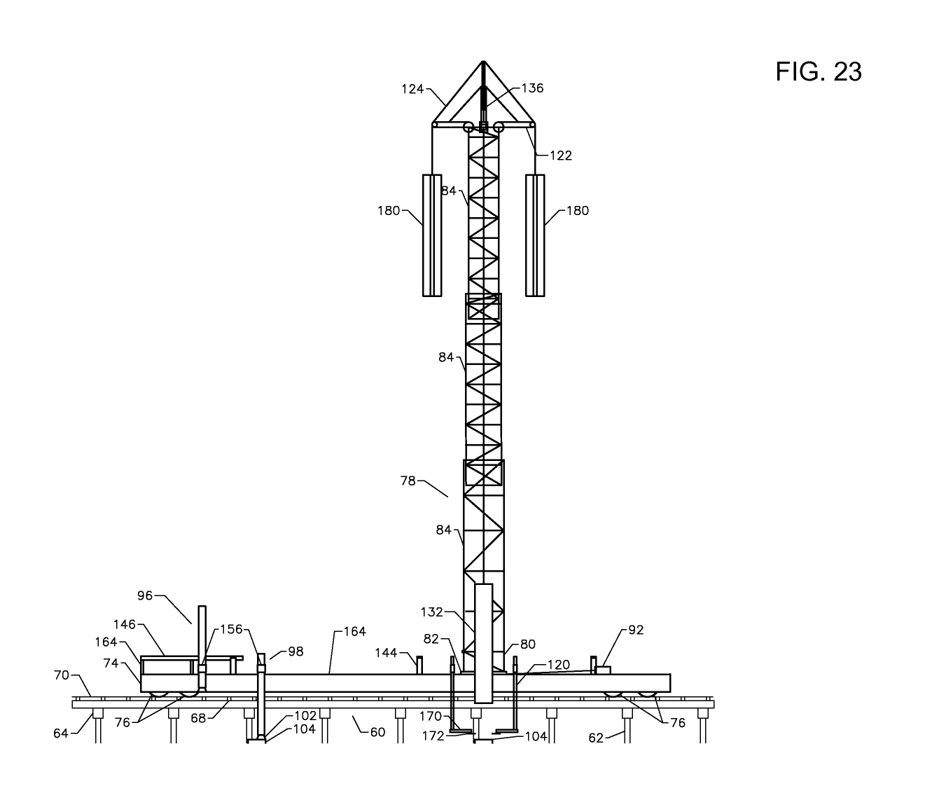

As shown in FIG. 23, the pile cutoff saws 118 are located on each side of the railcar 72. As illustrated in FIG. 23 the cut off saws are preferably oriented such that there are multiple blades on the outer perimeter of each new pile 104 so that the cutoff saw blades can be rotated about the center of the pile 104 to facilitate complete cutting of the pile. Preferably there are pair of cutoff saws 118 located forward and aft of the pile positioning arms 130 on each side of the rail car so that an entire cut around the new pile maybe accomplished without repositioning the car 72 or the cut off saws. The cutoff saws comprise a vertical arm 120, a horizontal arm 170 to move the motor 174 and saw blade 172 in three dimensions to position the blade to cut the top of the new pile 104 at the desired elevation. As known by those of ordinary skill in the art, the pile cutoff saw blades 172 and motors 174 can be of any type suitable for cutting precast concrete or other pile materials.

### Installation Of New Piles

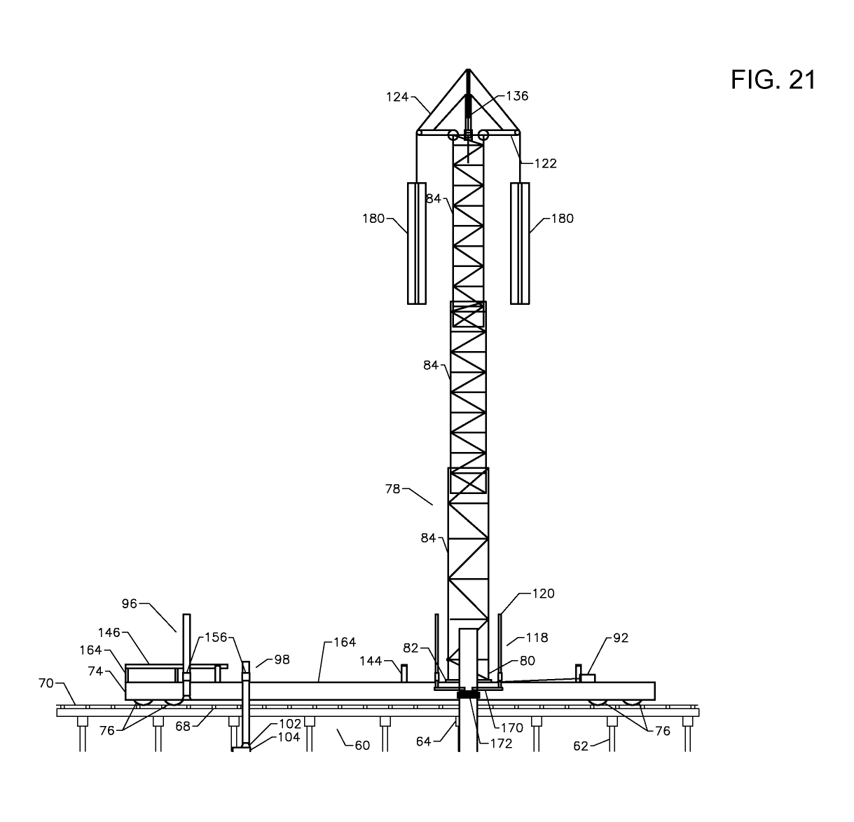

As shown in FIGS. 12-28, the rail car 72 can be positioned upon existing track to allow placement and driving of new piles. In the initial position illustrated in FIG. 12, at least one pair of the forward outriggers 9B or aft outriggers 96 are positioned against an existing or newly-installed pile 104 or other suitable support located on either side of the existing track. The outriggers may be extended to any suitable support foundation, including the ground surface beneath the existing bridge. This configuration provides the support necessary to stabilize the rail car 72 during the erection and pile-driving operations. The outriggers are illustrated in locations aft of the vertical tower, but may be mounted at any location on the length of the rail car as required to provide stability.

In this position, as shown in FIG. 19, the new piles 104 can be lowered using the hoisting cable 124 so that they can be received and positioned by the pile positioning arms 130 located on either side of the rail car 72. As the pile 104 is lowered into position for driving, the pile positioning arm 130 can be used to secure the pile in the desired driving position, as shown in FIG. 19. Then the hoisting cable 124 is disconnected from the pile 104 and the tower can again be rotated 90° to the pile driving orientation, as shown in FIG. 20. In this orientation, the pile hammers 116 may be lowered into position on the respective new piles 104 on either side of the rail car 72 to drive the new piles 104 into the desired position.

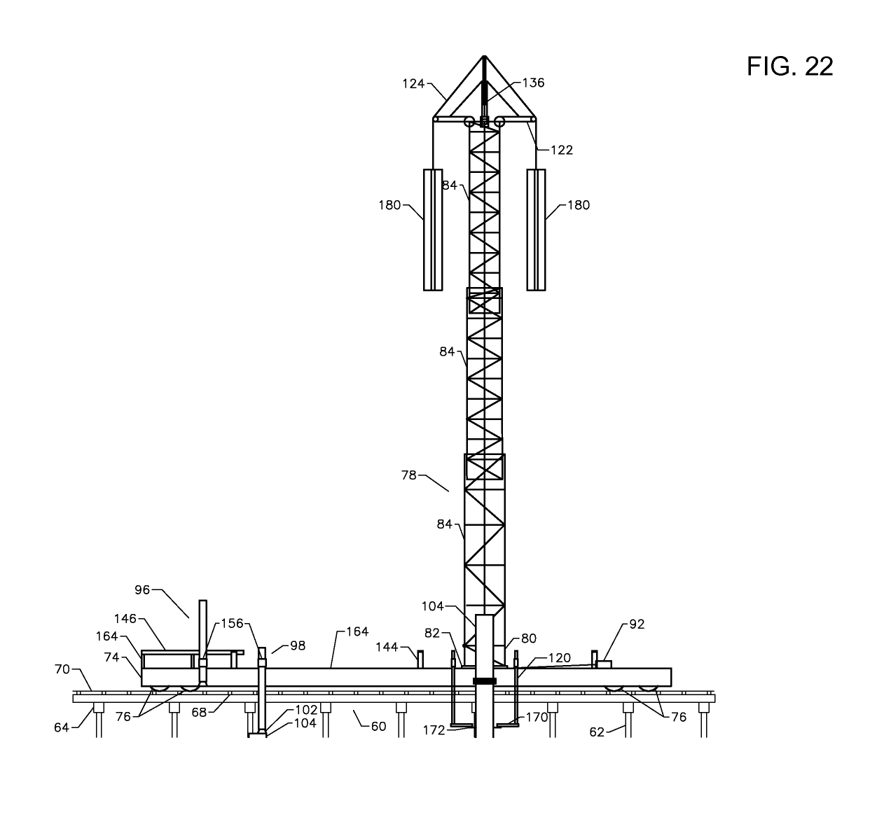

Once the pile has been driven to its desired position, as shown in FIG. 22, the pile positioning arms 130 can be retracted to their stowed position and the pile cut off saws 118 located on either side of the rail car 72 can be extended into position on the outer perimeter of the new pile 104 to cut the pile at the desired surface level. The pile cutoff saws 118 provide a precise orientation of the cut surface of the new pile 104 by using the existing rail 70 as a reference point.

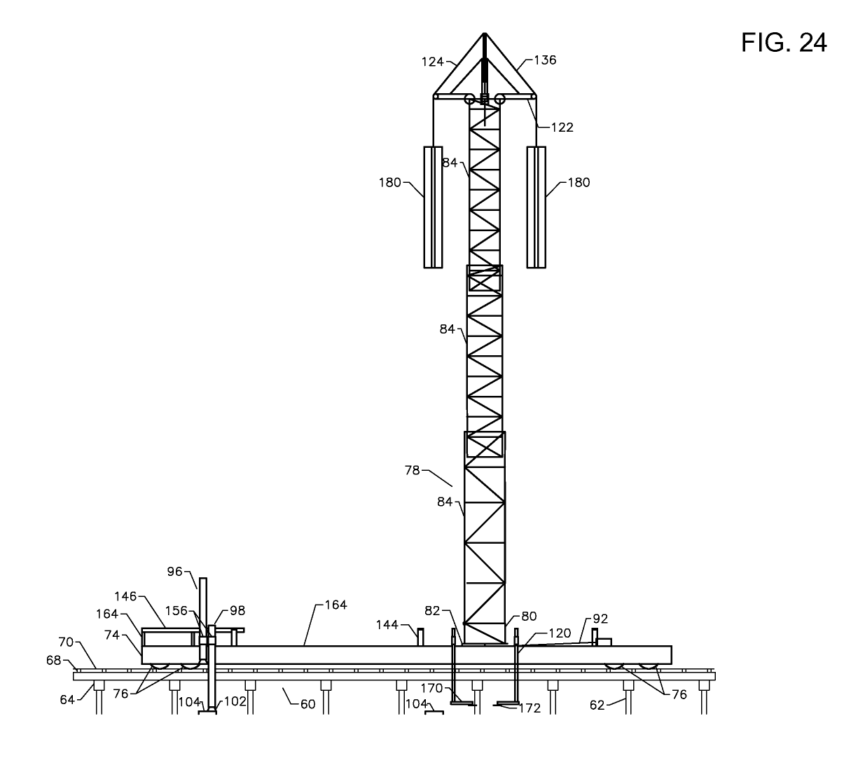

As shown in FIG. 22, prior to the commencement of the sawing operation, the tower is rotated 90° to the pile installation orientation and the hoisting cables 124 are reattached to the upper portion of the new piles 104 to secure the excess pile portion “drop” 132, which will be separated from the pile by the sawing operation. By keeping tension on the hoisting cable 124, the weight of the excess pile portion 132 is kept off the blades of the pile cut off saws 118, and the effectiveness of the sawing operation is enhanced. When the sawing operation is complete, the excess pile portions 132 are raised as shown in FIG. 23. Then as shown in FIG. 24, the tower assembly 78 is rotated to offload the drop 132. The drop 132 can then be loaded onto the rail car 72 or the material transport cars for proper disposition, and the tower can then hoist the next piles for installation.

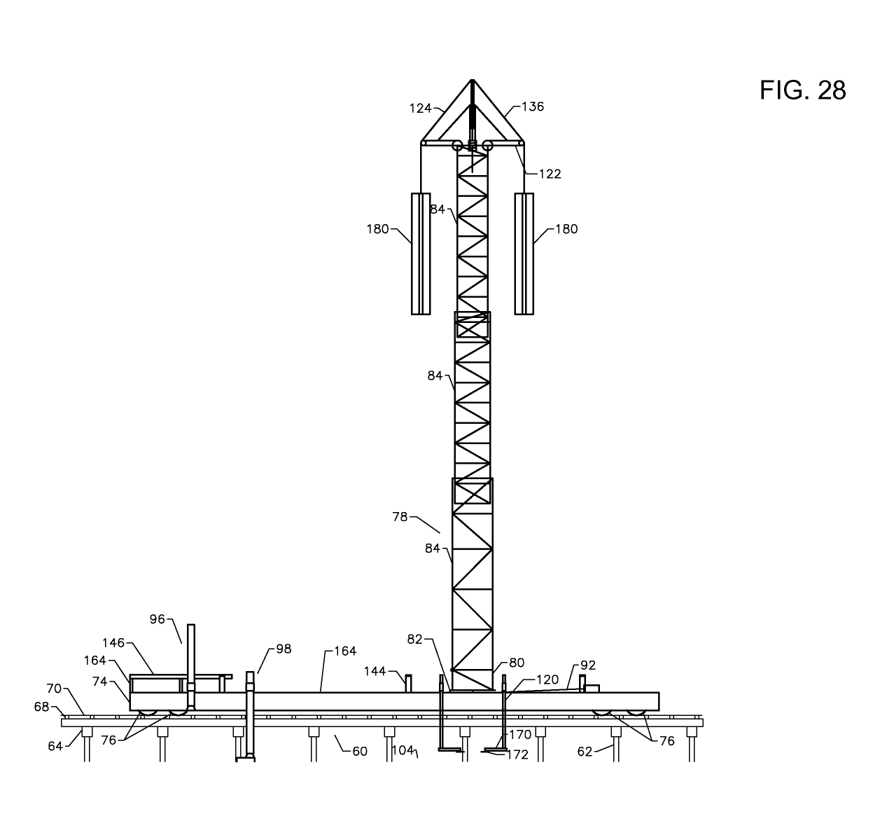

To facilitate the offloading of the drop 132, the present invention preferably includes a table located along the approximate centerline of the rail car bed 74 to support the drop 132, which is substantially shorter than the original pile, for offloading such that it does not interfere with the outriggers or outrigger track mounted to the platform 74. As shown in FIGS. 2 and 28, the rail car 72 is preferably equipped with a stationary pile drop table 146 at the aft portion of the platform 74, which is located sufficiently aft such that does not interfere with the operation of the outriggers or the outrigger tracks. The rail car 72 is also preferably equipped with a movable pile drop table 164 adjoining the stationary pile drop table 146 configured such that the pile drop 132 may be slid or rolled on rollers installed along the pile drop tables 164 and 146 to an adjoining material transfer car for removal from the work site. The movable pile drop table 164 may be raised or lowered into the desired position using various means, including hydraulic, mechanical or electrical drives. The movable pile drop table 164 may thus be lowered to a position level with the surface of the platform 74 so as to avoid interference with the movement of the outriggers during repositioning of the railcar 72.

Once the upper surface of each of the piles has been prepared, the rail car is subsequently repositioned for installation of the next pair of new piles 104. Because the tower 78 preferably remains in its vertical position and carrying pile hammers 116, at least one pair of outriggers 96 or 98 preferably remain in position against the initial support to maintain stability of the rail car 72 while the other pair of outriggers 96 or 98 is repositioned over the newly installed pile 104.

### Outrigger Repositioning

In one preferred embodiment, as shown in FIGS. 23-28, the pair of aft outriggers 96 is mounted in a fixed position slightly aft of the aft end of the outrigger tracks 100, and the pair of forward outriggers 98 is slidably mounted on the outrigger tracks 100. To avoid interference between the forward outriggers 98 and the tower during the installation of the new piles 104, the forward ends of the outrigger tracks 100 are preferably located sufficiently aft of the tower 78 to maintain the forward outriggers 98 a clearance distance X aft of the tower 78 centerline. Alternatively, the forward outrigger may be to mounted forward of the vertical tower. To avoid interference between the forward outriggers and the tower during installation of the new piles, the aft end of the outrigger tracks are preferably located a sufficient distance X forward of the tower to maintain an adequate clearance between the forward outriggers and the tower.

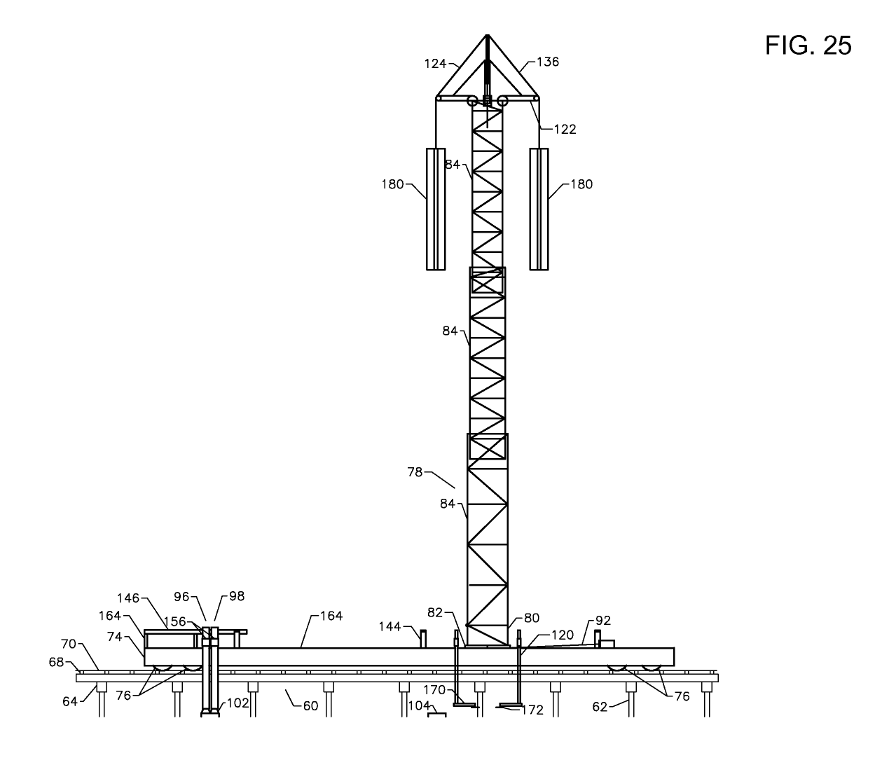

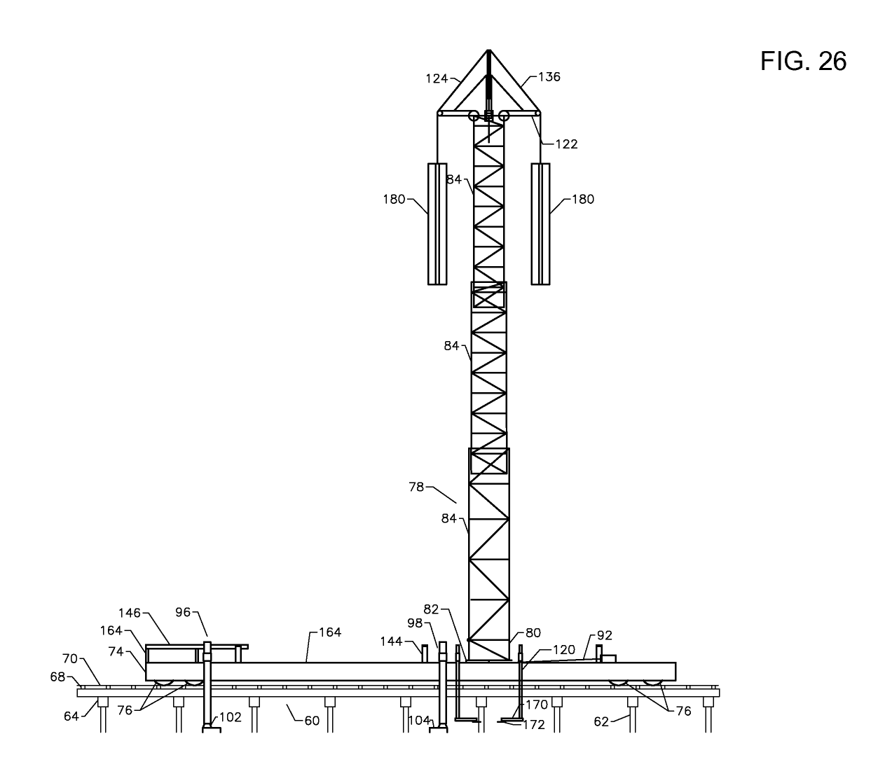

As shown in FIG. 23, to provide at least one pair of outriggers 96 or 98 in position against the initial support in order to maintain stability of the rail car 72 while it is relocated, the pair of forward outriggers 98 remains in position on the initial support or previously set pile 104 or other suitable support, in slidable contact with the outrigger tracks 100. Then, as shown in FIG. 24, the rail car moves forward the clearance distance X, such that the forward outriggers 98, slide along the outrigger tracks 100 to the aft end of the tracks, thus remaining in a fixed positioned on top of the initial support or previously driven new pile 104. During this process the aft outriggers 96 also travel forward a distance X with the rail car 72 and, as shown in FIG. 25, may be lowered into position over the previously set pile 104, alongside the forward outriggers 98. Then, as shown in FIG. 26, with the rail car 72 stabilized by the aft outriggers 96 in position on the previously set pile 104, the forward outriggers 98 are raised and repositioned to the forward end of the outrigger tracks 100, so that they can be lowered into position on the most recently installed piles 104 or other suitable support, including the ground beneath the railroad bridge.

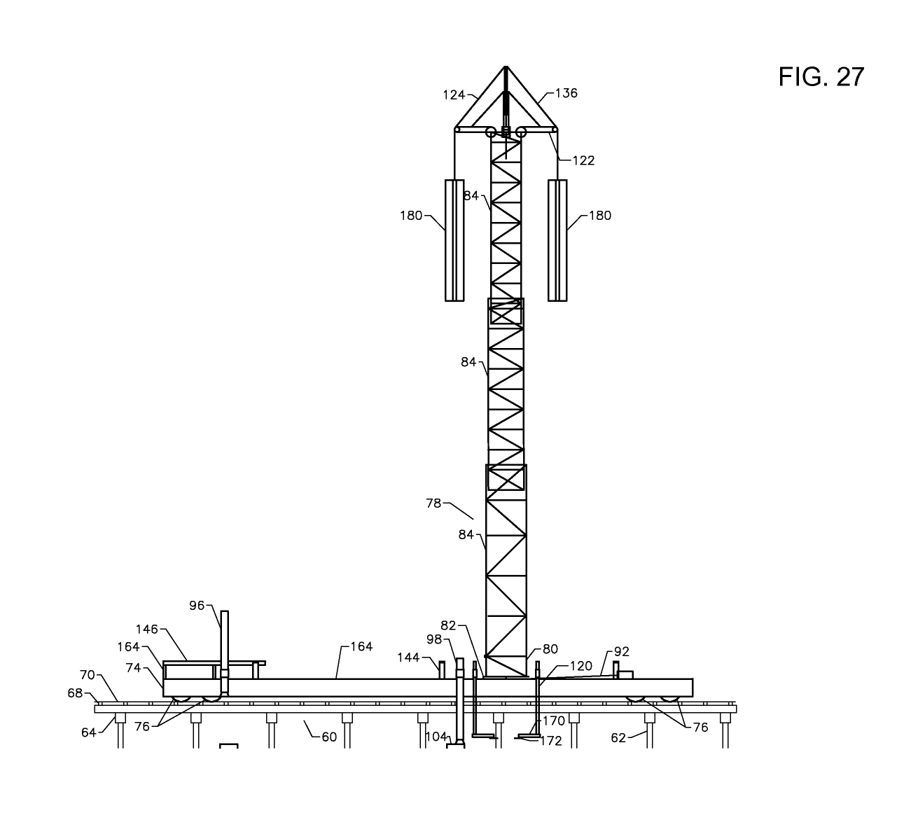

As shown in FIG. 27, once the forward outriggers 98 are positioned on previously set pile 104, the aft outriggers 96 may be raised and, as shown in FIG. 28, the rail car further advanced along the rails 70 to the proper span length distance for repositioning for installing the next new pile 104. The rail car moves forward a distance equal to span distance-X, while the forward outriggers 98, in slidable contact with the outrigger tracks 100, remain positioned on top of the newly driven piles 104 as shown in FIG. 28 or other suitable foundation.

Once this configuration is established as shown in FIG. 28 with the forward outriggers 98 positioned on the top surface of most recently installed piles 104 or other suitable foundation, the installation process for the next two new piles can commence as previously described in relation to FIGS. 16-23. As may be appreciated by one skilled in the art, the method of the present invention may be carried out with a variety of alternative configurations of fixed and/or movable outriggers.

### Staging Area

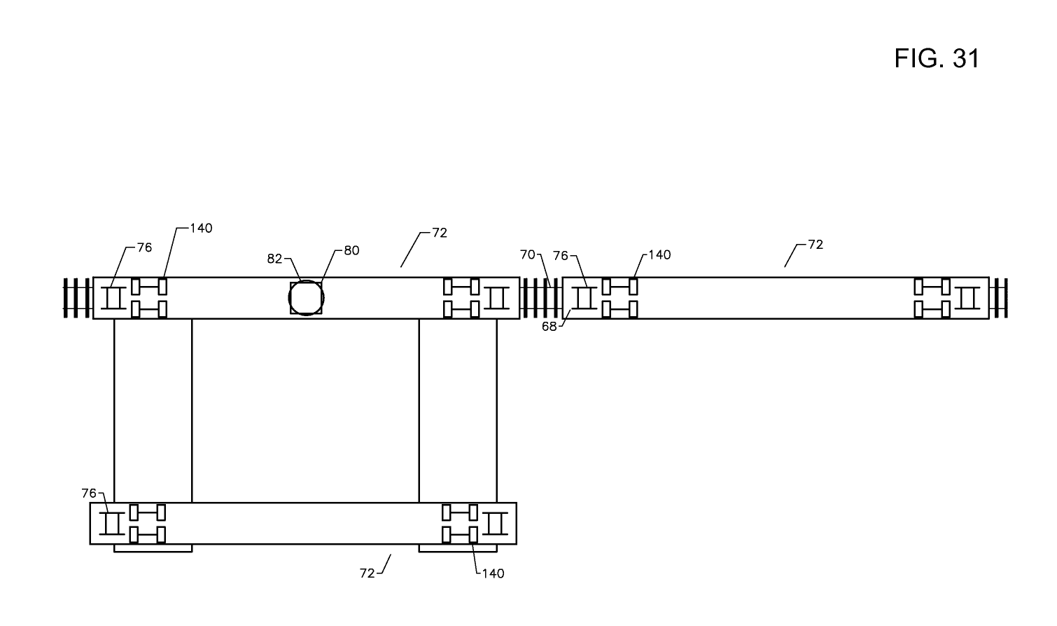

The staging area may be located at any convenient location to minimize the travel time from the construction site to maximize the opportunity for construction activities. As shown in FIG. 31, the staging area preferably includes a rail-level improved surface 142, such as a pavement surface found at typical railroad crossings. Preferably at the commencement of construction activities the rail car 72 is relocated from the staging area to the existing track using a set of ground wheels 140 mounted to the platform on axles substantially parallel to the longitudinal axis of the platform. The ground wheels comprise any type of rotating component suitable for locomotion over an improved or unimproved ground surface, including all types of pneumatic or solid wheels, or a tracked drive system, such as used on cranes and earth moving equipment. This set of ground wheels 140 is preferably mounted to the platform with a lifting mechanism such that the set of ground wheels 140 can selectively be lowered to raise the platform and rail car wheels 76 off the rails, and support the platform on an improved surface 142. Then the rail car can be pushed, towed or driven on the improved surface 142 to the tracks, where it can be lowered such that the rail car wheels 76 contact the rails 70. As is known and appreciated in the art, there are many types of wheels and mounting devices that may be used to accomplish the purpose of the ground wheels 140, including, for example, the type of wheels used on self propelled modular transporters (“SPMT”).

Alternatively, a variety of lifting devices, including the aft outriggers 96 and forward outriggers 98, may be used to raise the platform off the rail car wheels 76 and to “walk” the rail car 72 away from the tracks, or to lower the platform onto a trailer or other type of wheel-equipped device on the improved surface 142.

Similarly, when the construction operations are suspended to abide by the pre-established curfew restrictions, the rail car 72 and any material transport cars are preferably transported to the staging area where they can be demounted from the track to allow scheduled rail traffic to resume. Once the rail car 72 is positioned on the track adjacent to the staging area, the second set of wheels 140 can be actuated to lift the rail car 72 off the rail 70 such that the rail car wheels 76 are no longer in contact with the rails 70. At this point the second set of wheels 140 can be used to reposition the rail car 72 to the staging area and clear of the railroad traffic on the track so that scheduled traffic can be resumed. This method avoids the necessity for construction or use of a rail siding which would involve substantial expense and longer travel time on the main rail.

### Pile Transport Car

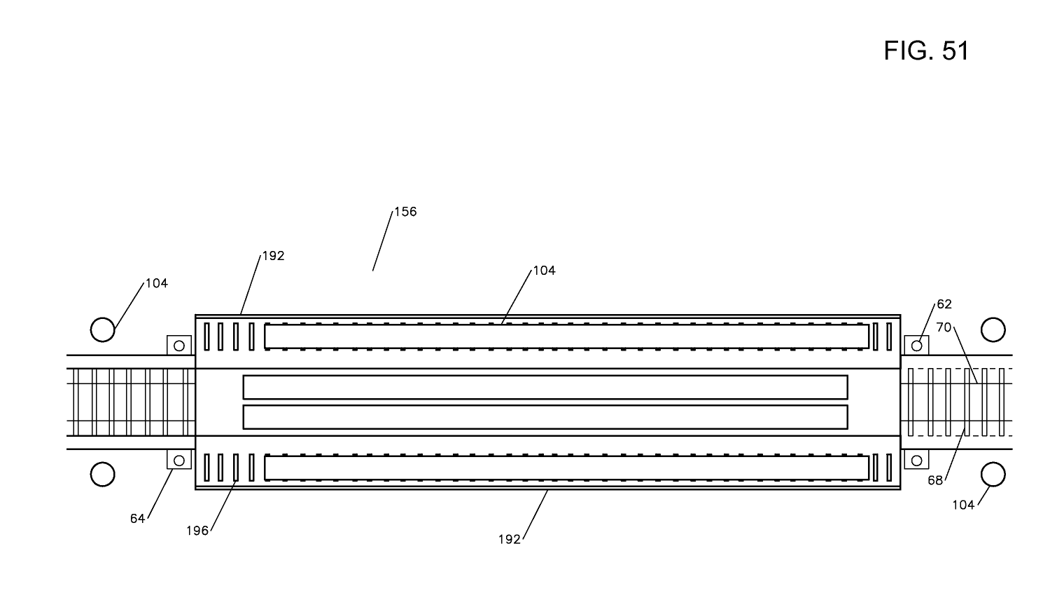

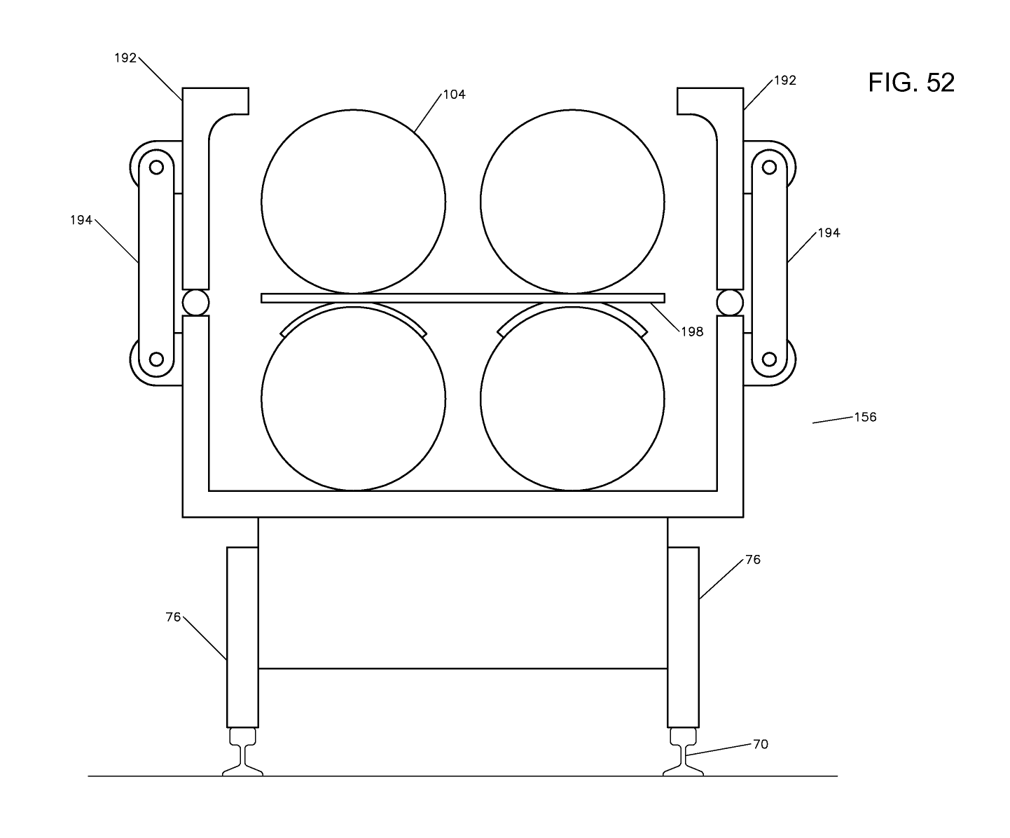

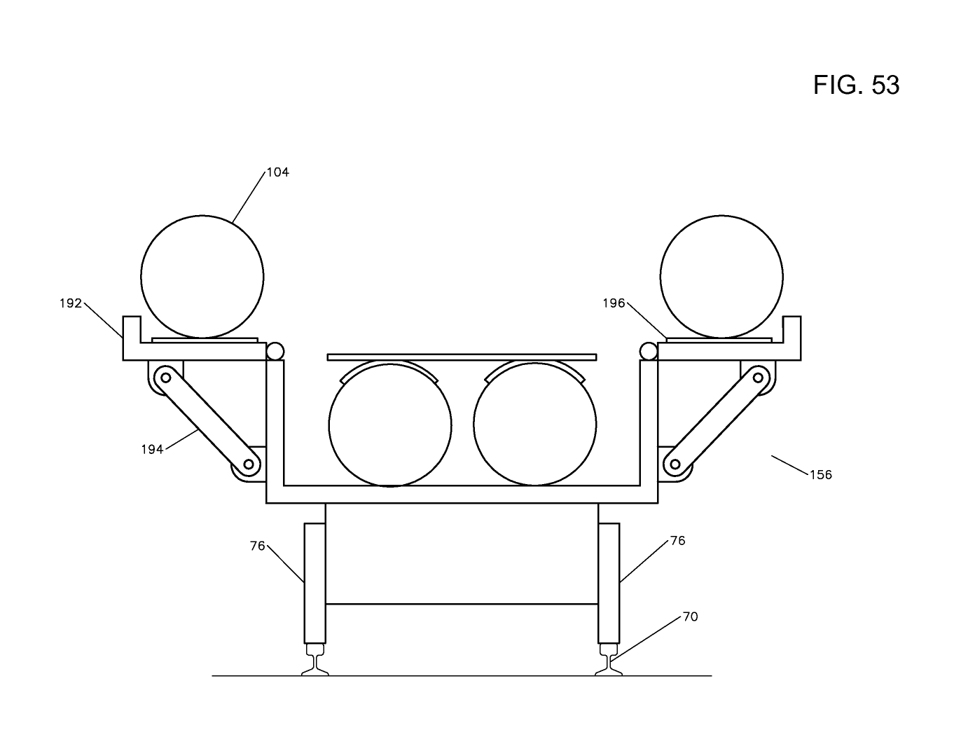

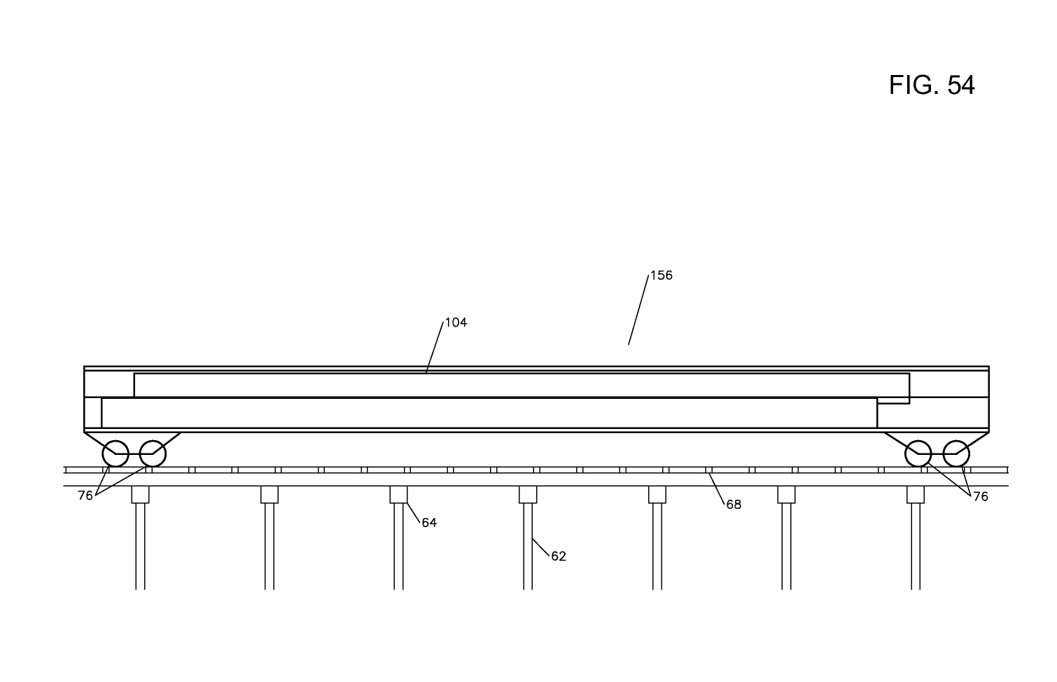

Because the pile may not be structurally sound enough to be erected from a stowage orientation by lifting from the upper end of the pile, it is preferable to lift the pile from a position approximately one third of its length to minimize bending stresses. Accordingly, to facilitate lifting from this support location on the pile, a pile transport car 156 is provided as illustrated in FIGS. 51-54. FIG. 51 is an overhead (plan) view of the pile transport car 156 with side walls in open position and the pile positioned for offloading. FIG. 52 is a cross-section view of the pile transport car 156 with the side walls in closed position and pile stowed for travel. FIG. 53 is a cross-section view of the new pile storage and transportation rail car with the side walls in the open position and pile positioned for delivery. FIG. 54 is a side view of the pile transport car 156 with the side walls in the closed position and the pile stowed for transportation.

The pile transport car 156 allows the piles to be transported in a position near the centerline of the rails so that the stability of the pile transport car 156 is maintained, and allows the piles to be positioned sufficiently outboard from the rail centerline for offloading onto the rail car 72 for hoisting from a position sufficiently outboard from the centerline to avoid interference with the tower 78.

As shown in FIG. 53, the pile transport car 156 is equipped with hinged side walls 192 which may be opened outward to provide a substantially horizontal surface for supporting the piles 104 during offloading, including multiple roller assemblies 196 to facilitate offloading. The roller assemblies 196 are preferably of the types used to support conveyor belts or other conveying systems. The hinged side walls 192 are supported in the open position by side wall support brackets 194 or other type of bracing member which may be manually or power operated, such as prop rods, hinged brackets, hydraulic cylinders, actuators, screw drives, cables, etc. The piles 104 may be rolled from the inboard traveling position to the outboard position on the lowered side walls 192 for offloading by use of a winch or other type of device. The pile transport car 156 is preferable equipped with a lifting mechanism on the platform to elevate the lower level(s) of piles to the elevation of the substantially horizontal surface provided by the opened hinged side walls 192 for offloading. The lifting mechanism may operate by hydraulic, electrical or other means.

As shown in FIG. 52, multiple piles can be carried in the pile transport car 156 in a stacked configuration using a conformed support 198 between layers of the stacked piles. The conformed support 198 also provides a surface for rolling the upper layer of piles 104 from the traveling position as shown and 52 to its offloading position shown in FIG. 53. When the pile is in the offloading position on the hinged side wall 192, it is supported by multiple roller assemblies 196 to facilitate rolling to the rail car 72 into hoisting position alongside the tower 78.

### Cap Installation Rail Car

The installation of new pile caps on the upper surfaces of the newly installed piles 104 can similarly be accomplished using a cap installation rail car 182. Because the vertical lift distance required for the installation of the new pile cap 108 is much less than required for the installation of new piles 104, a tower of significantly less height can be used.

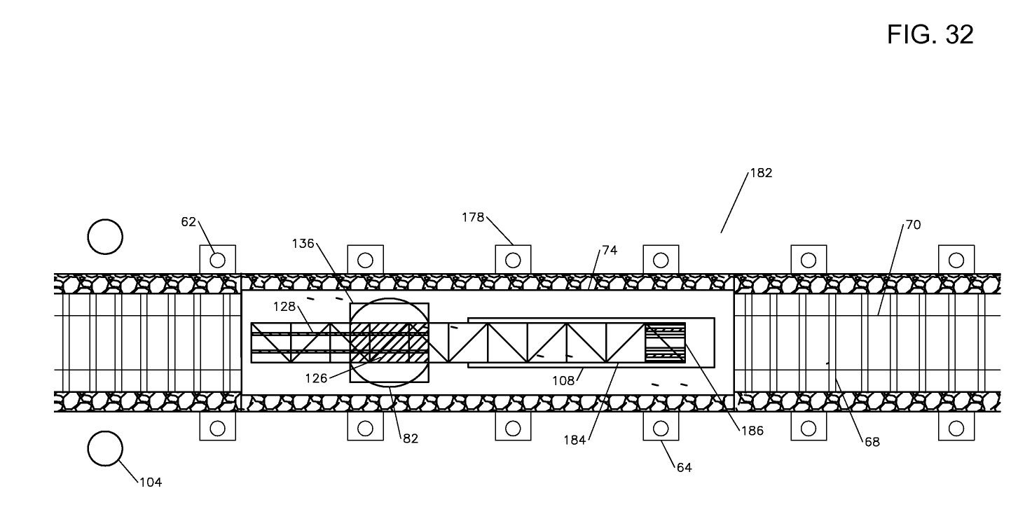

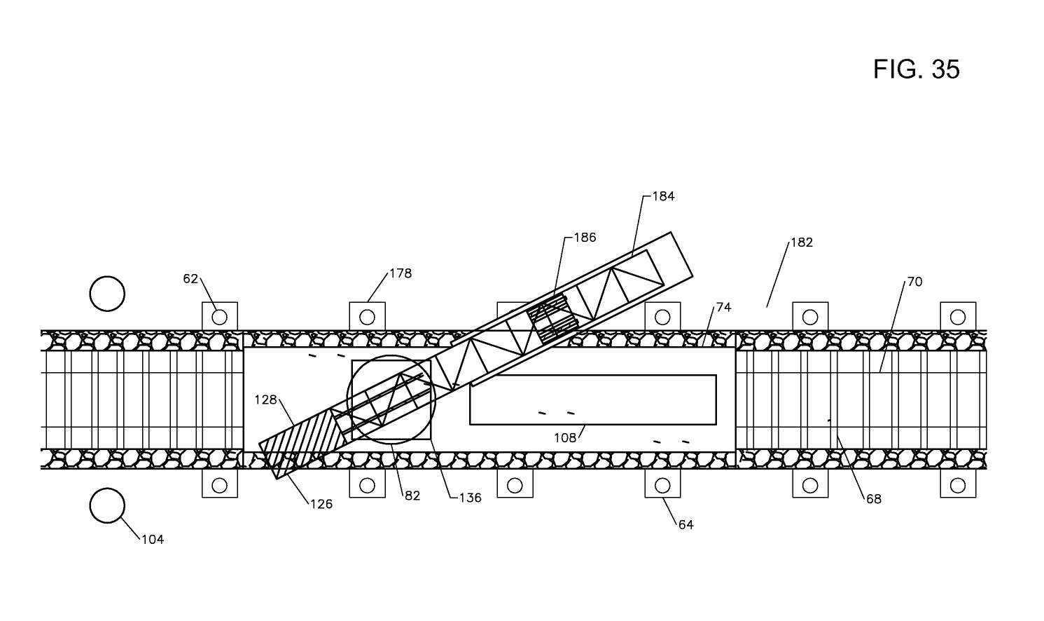

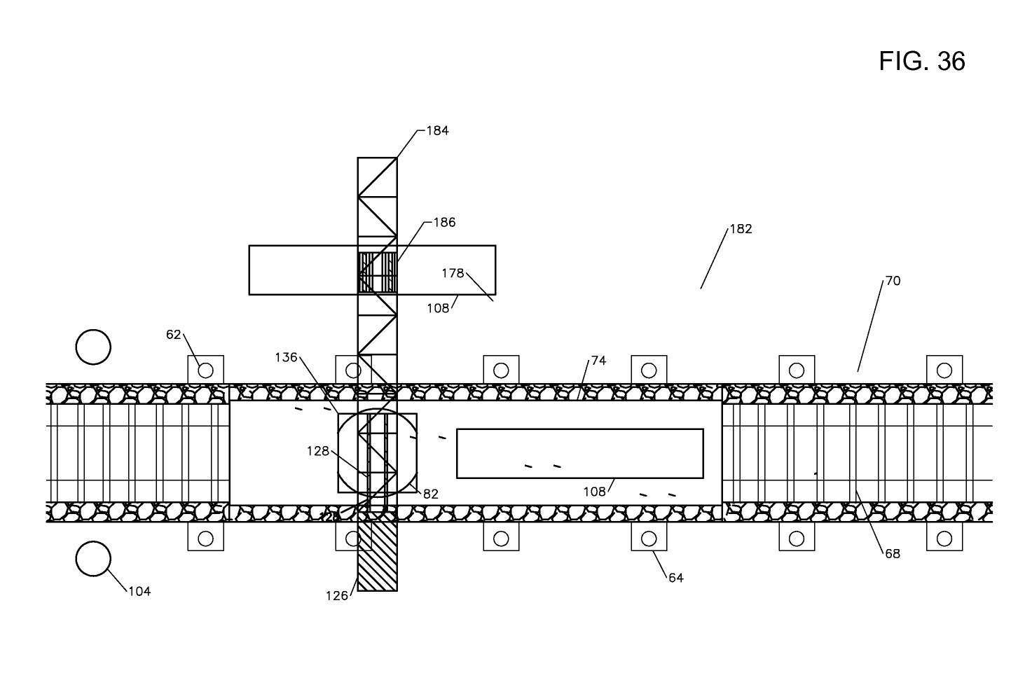

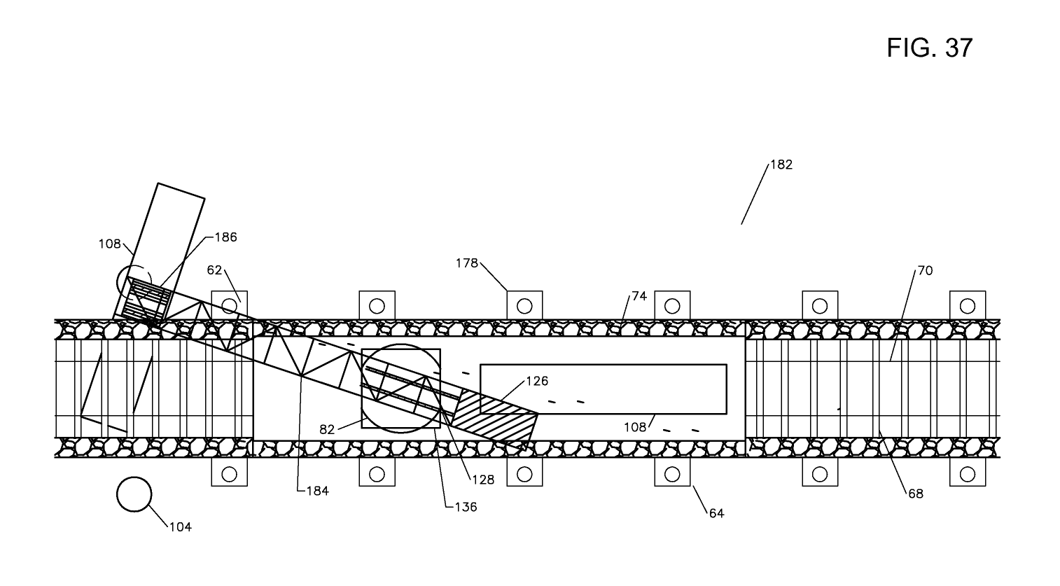

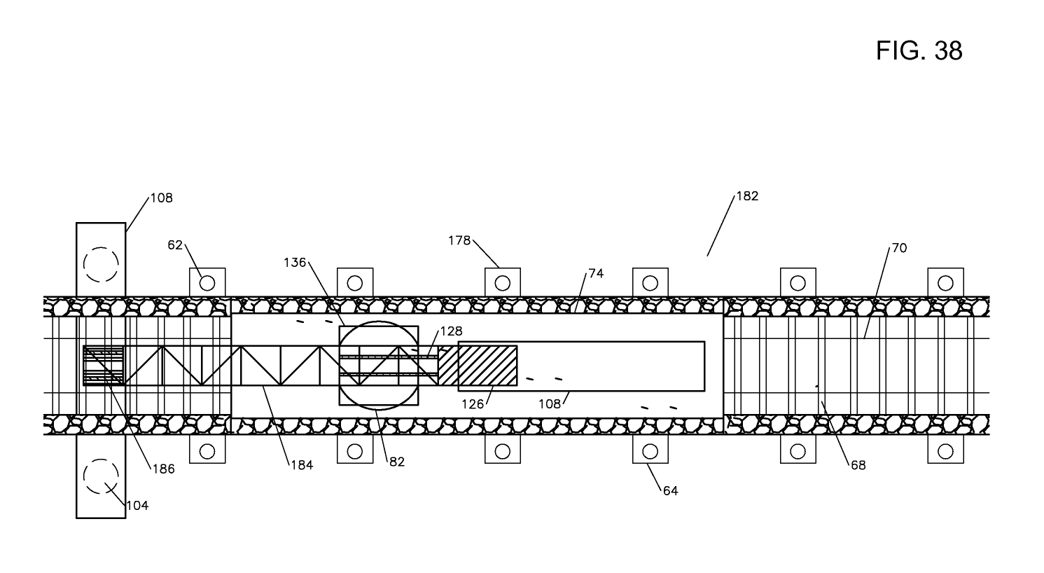

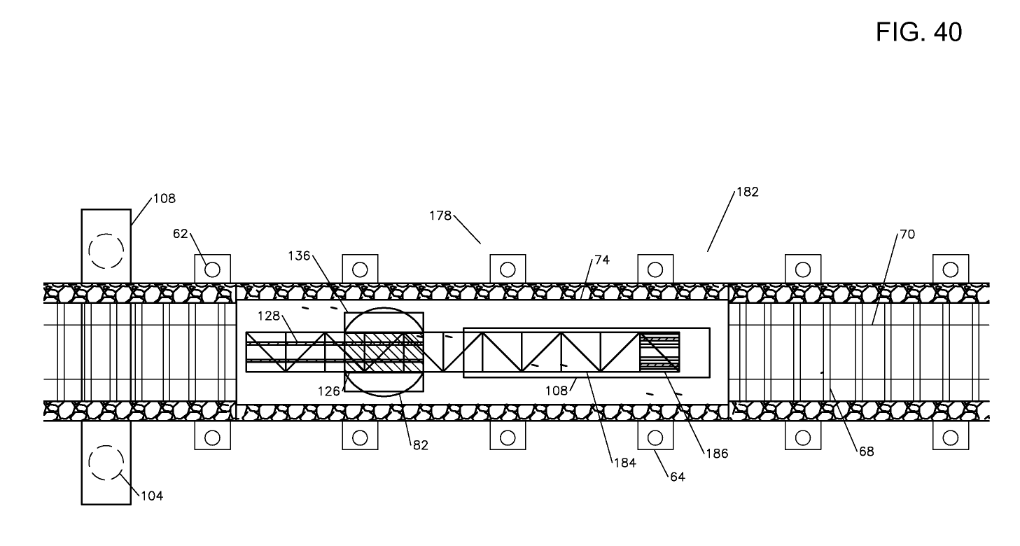

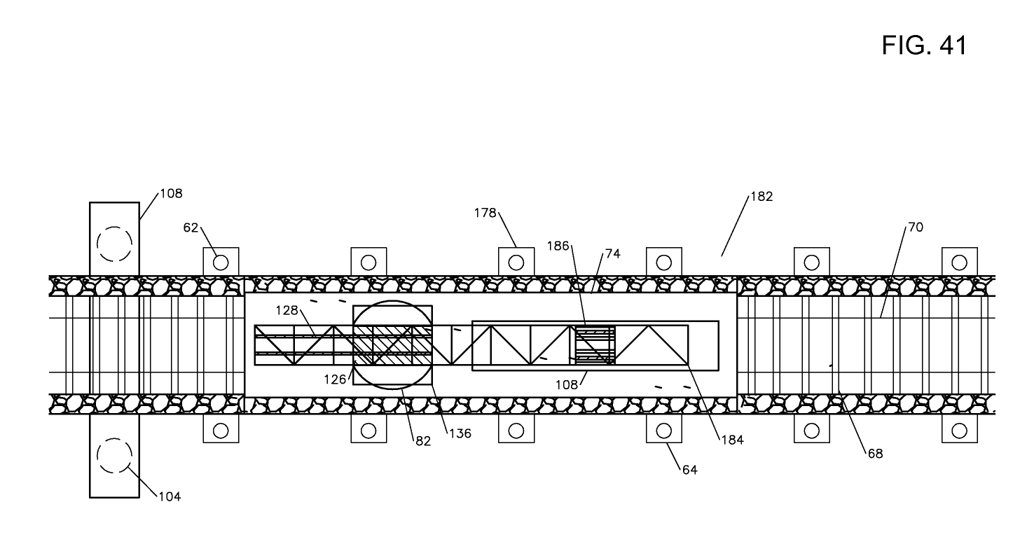

As shown in FIGS. 32-42, the pile cap installation rail car 182 comprises a substantially flat platform 74 which is supported by wheels 76 on the existing rails 70. The rail car also comprises a vertical tower 136 which is mounted on a rotating base 80 by use of a rotary bearing 82. The rotating base allows the tower 136 to be rotated during operation to lift a new pile cap from the forward portion of the car 182 or adjacent material transport car and to install it on the upper surfaces of a pair of new piles 104 located near the forward or aft end of the car 182.

The pile cap installation rail car 182 may also comprise outriggers mounted at any location on the length of the rail car as required to provide stability. Each outrigger may be configured with an outrigger foot to provide support when positioned on the upper surface of a newly installed pile 104 or pile cap 108 along the existing railroad bridge 60 or when extended to any suitable support foundation, including the ground surface beneath the existing bridge.

The pile cap installation rail car 182 may also comprise a set of ground wheels 140 mounted to the platform 74 on axes of rotation substantially parallel to the longitudinal axis of the platform as previously described for the rail car 72. This set of ground wheels 140 is preferably mounted to the platform with a lifting mechanism such that the set of ground wheels 140 can selectively be lowered to raise the platform and rail wheels 76 off the rails, and support the platform on an improved surface 142. Then the rail car can be pushed, towed or driven on the improved surface 142 to the tracks, where it can be lowered such that the rail car wheels 76 contact the rails 70.

### Cap Car Vertical Tower

The vertical tower 136 supports a boom 184 or arm, which is equipped with a slidably mounted trolley 186. The trolley 186 supports a hoisting cable 124 with an end fitting or fixture that is configured to be secured to a new pile cap 108.

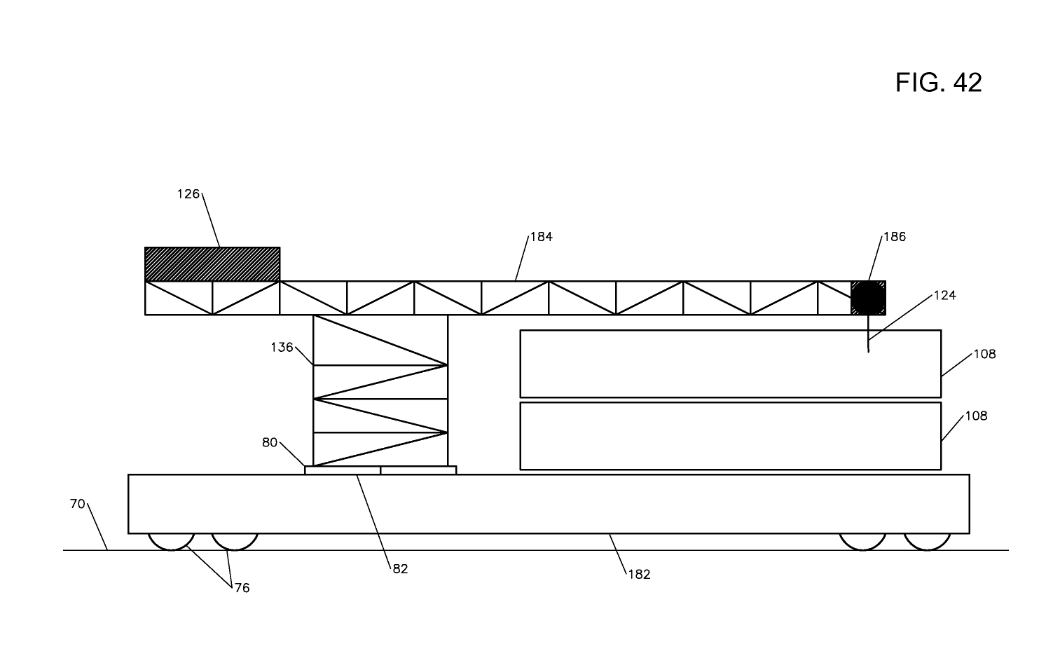

As shown in FIG. 42, the tower 136 is configured with a minimum height sufficient to install pile caps to avoid interfering with the ability of the rail car to be transported by means which have height limitations, such as by truck transportation over highways with bridges or overpasses. The vertical tower is rotated using a tower-based drive motor 94 which may be powered by electric, hydraulic, pneumatic or other power sources which are available at the construction location.

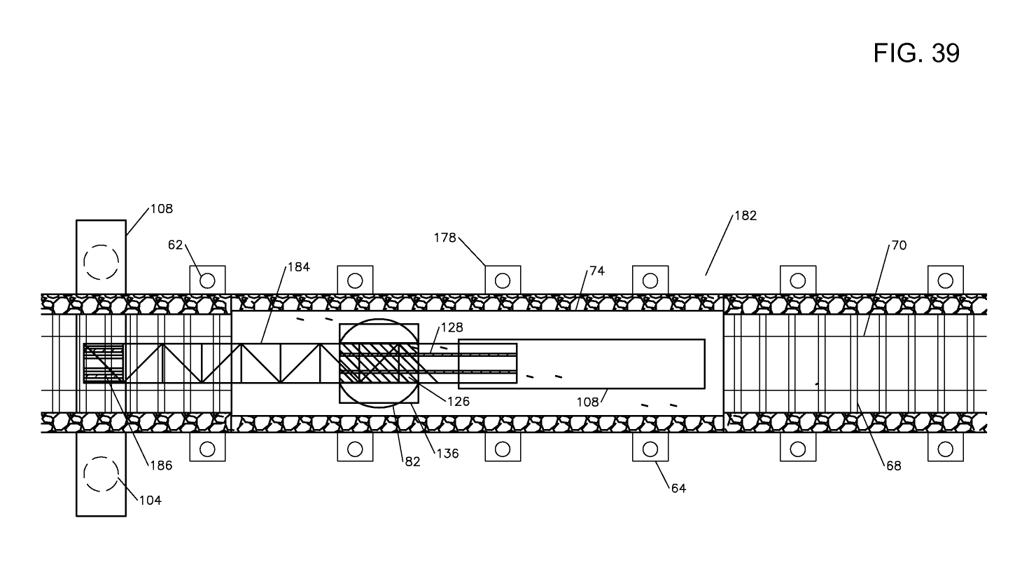

The tower preferably includes a counterweight 126 slidably mounted on the opposite end of the boom 184 as the trolley 186 by a counterweight track 128. The counterweight 126 is positioned to counterbalance the force necessary to lift the new pile cap 108, so that the forces necessary to stabilize the tower are minimized. As shown in FIGS. 39-42, the counterweight 126 is positioned near the vertical axis of rotation of the tower when the boom is in the unloaded position. Preferably, the counterweight 126 is positioned automatically using a processor-based load moment indicator system, which uses a force transducer, such as a strain gauge on the hoisting cable 124 or trolley to determine the magnitude of the load, and a electrically-based position indicator, such as a Linear Variable Differential Transformer (“LVDT”) for the trolley to determine the moment arm distance from the tower of the load. As is well known in the art, the location of the trolley 186 can also be determined through the use of other types of sensors and indicators, such magnetic, optical, infrared, or ultrasonic. By multiplying the vertical load applied to the trolley by the moment arm distance of the trolley from the centerline of the tower 136, the processor calculates the overturning moment imposed on the tower. By positioning the counterweight 126 of known weight the appropriate distance in the opposite direction from the tower, an equal and opposite moment can be induced. The counterweight 126 can be positioned the appropriate distance from the tower using electro-mechanical means, such as a servo motor using a rack and pinion mechanism, or a cable driven by an electric motor connected to the counterweight 126. Alternatively, hydraulic, pneumatic or other power sources may be used.

### New Pile Cap Installation

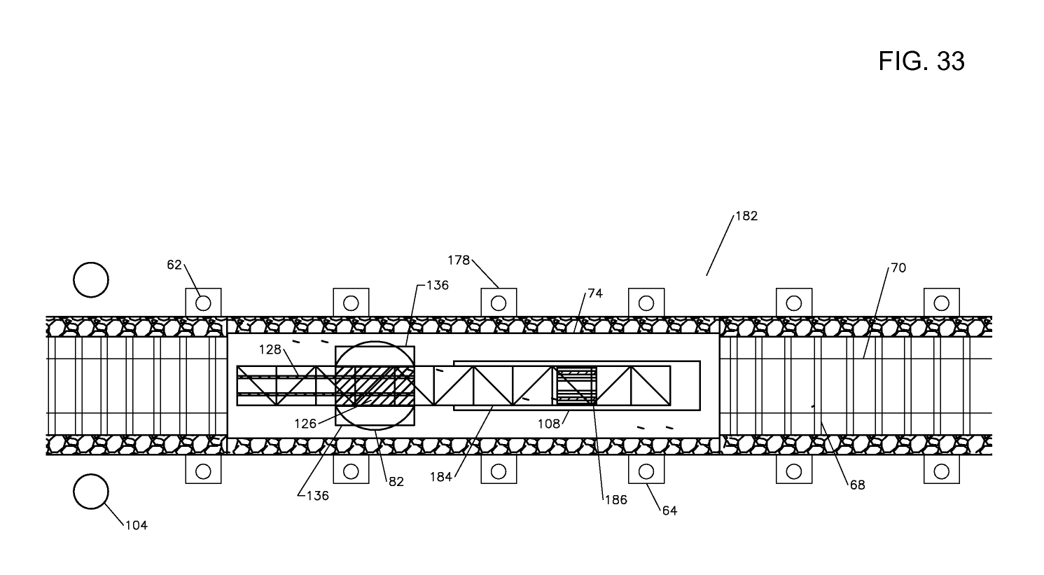

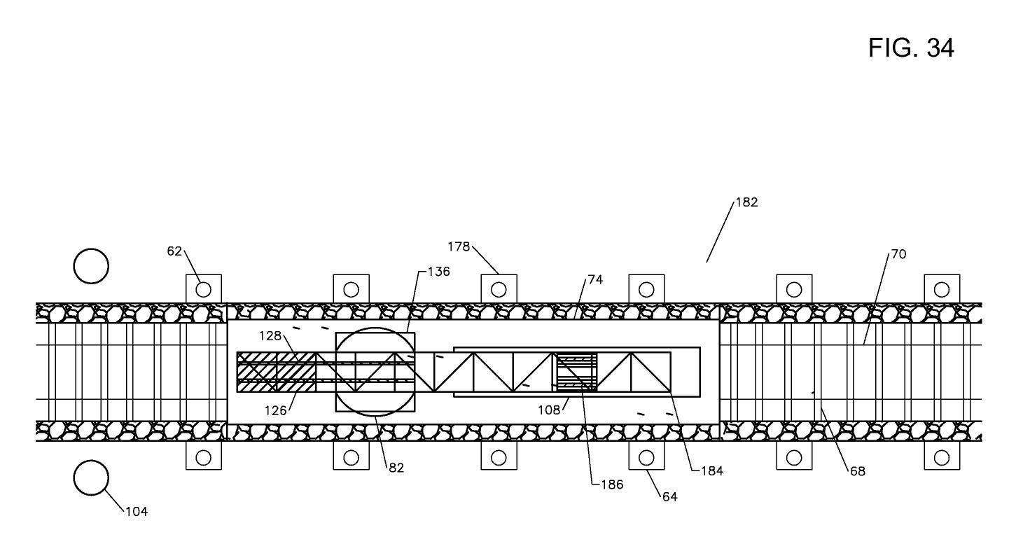

As shown in FIG. 33, once pile cap rail car 182 is in position with the boom 184 for lifting new piles caps 108 oriented parallel to the rail axis, the hoisting cable 124 can be attached to the pile cap 108 on the rail car 182 or adjacent material transport cars. As shown in FIGS. 34 through 38, by shifting the counterweight 126 away from the center of the boom 184 as the pile cap 108 is lifted by hoisting cable 124, the overturning moment on the tower 136 is balanced, and the forces necessary to stabilize the tower are minimized.

Once the pile cap is fully supported by the hoisting cable 124, the vertical tower 136 can be rotated on the rotating bearing 82 on the rotating base 80 so that the pile cap 108 is positioned under the rails 70 of the existing railroad bridge 60 to be installed on top of the pair of new piles 104.

Once the new cap 108 is in position on the upper surface of the new piles 104, the hoisting cable 124 may be disconnected from new cap 108.

### U-Shaped Picking Frames

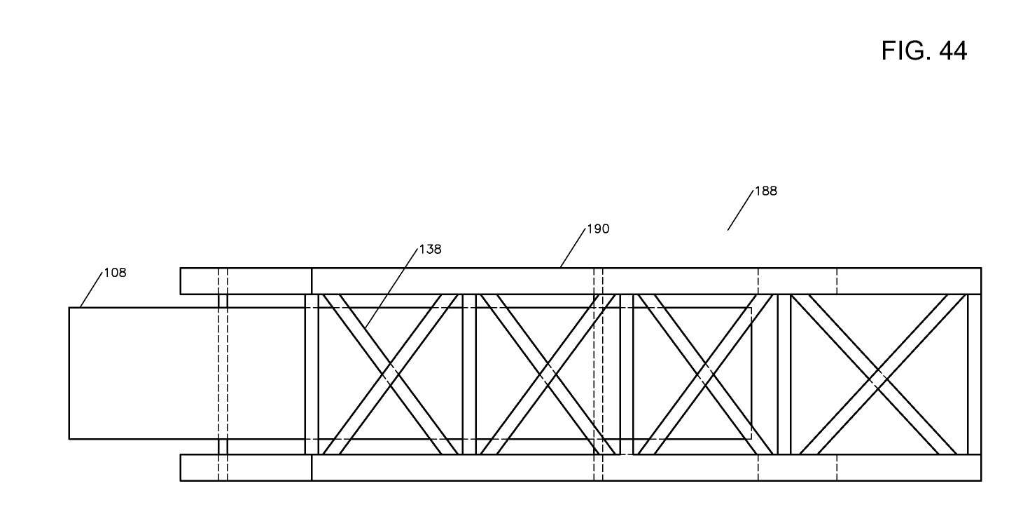

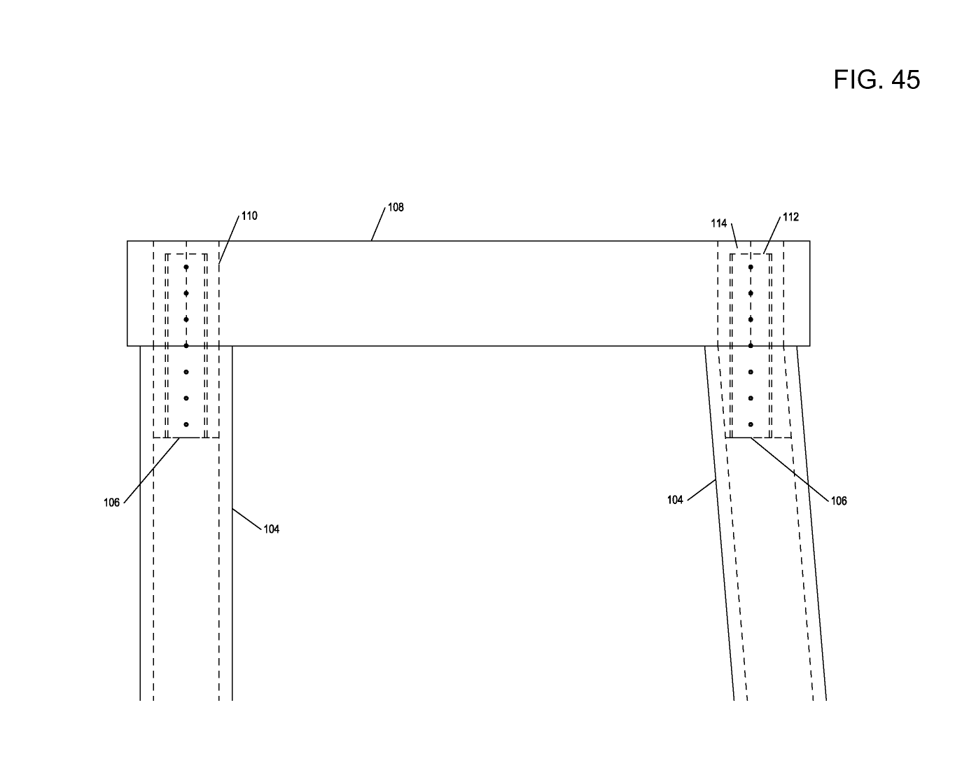

The installation of a new pile caps 108 can be facilitated by the use of one or more generally U-shaped picking frames 188 as shown in FIG. 44. The new pile cap may be suspended beneath the hoisting cable 124 by the picking frame 188 such that the opening in the U-shaped frame accommodates the existing rails 70 as shown in FIG. 45. As shown in FIG. 45, a pair of picking frames 188 with beams 190 or other connecting member suspended between them may be used to support the new pile cap 108 for installation. Upon placement of the pile cap 108 on the piles 104, the suspended beams 190 may be removed from the picking frames 188 to facilitate removal of the picking frames 188.

### Cap Attachment

As shown in FIG. 45, the cap is configured with a cap opening 110 which is designed to mate with the opening in the precast concrete piling 104 in either a vertical or battered orientation. The piling 104 also is configured with a pile inset 106. This inset is a steel or other platform which provides a containment for non-shrink grout or concrete 114 which will be installed to secure the piling to the cap. The pile inset 106 can be secured in position by supports such as brackets or pegs installed in the piling 104 by methods such as welding, or it may be suspended in position using straps, chains or other suspension devices from the upper surface of the piling or the new pile cap 108. A steel beam 112 or other structural member is then inserted in each pile cap opening 110 and into the interior of the pier 104 to rest atop the pile inset 106. This steel beam is preferably an H beam, pipe, an I beam, or other configuration to provide sufficient sheer resistance for a suitable connection between the pile 104 and the cap 108. Once the steel beam 112 is positioned in the center of the openings in the cap 110 and the pier, the remainder of the void in the openings is filled with non-shrink grout or concrete 114 to secure the beam 112 in position as shown in FIG. 45. Subsequent new pile caps 108 can be installed on successive pairs of new piles 104 in similar manner.

### Installation of New Bridge Spans

The same pile cap installation rail car 182 used to set the caps can be used to install new spans on the newly installed caps.

Once the new pier caps 108 have been installed on the new piles 104, pile cap installation rail car 182 may travel on the main rail or by other means and may lift the existing spans off of the bridge and onto a material transport car.

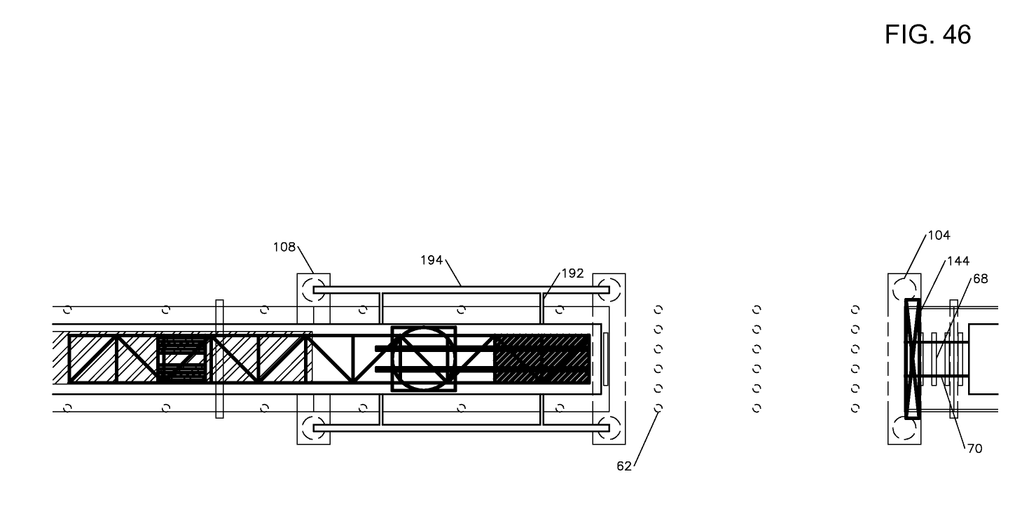

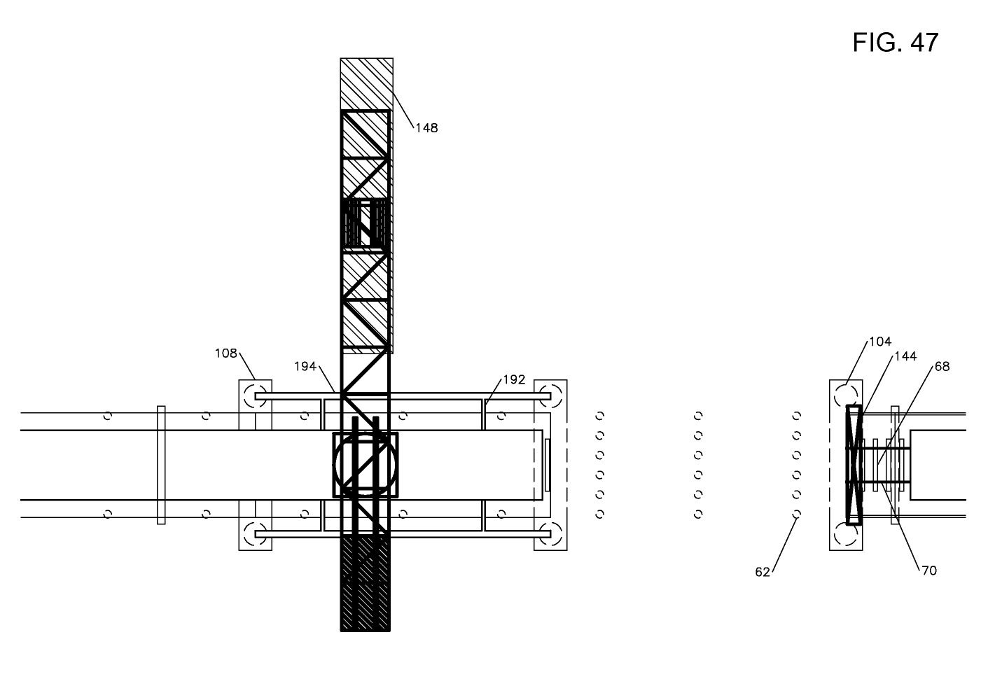

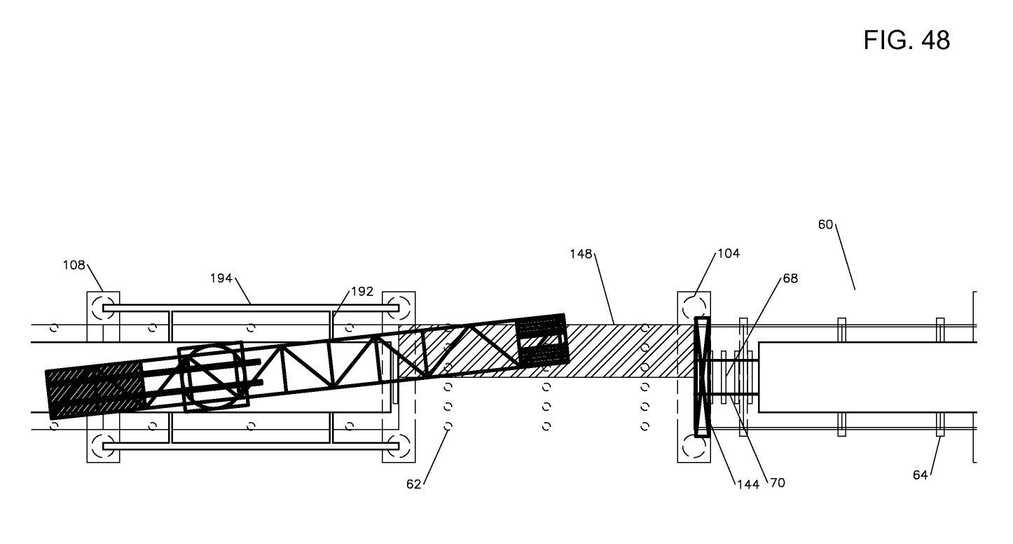

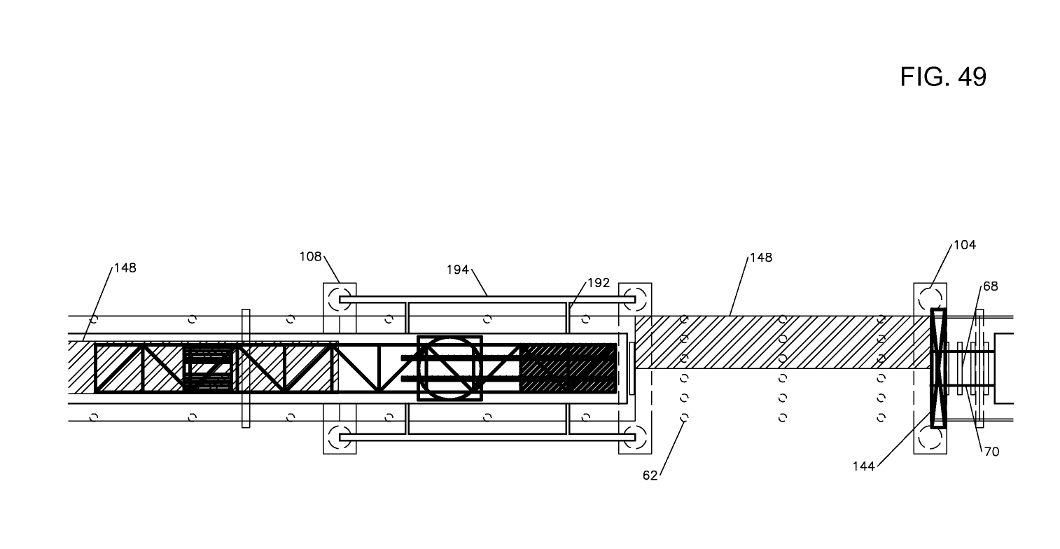

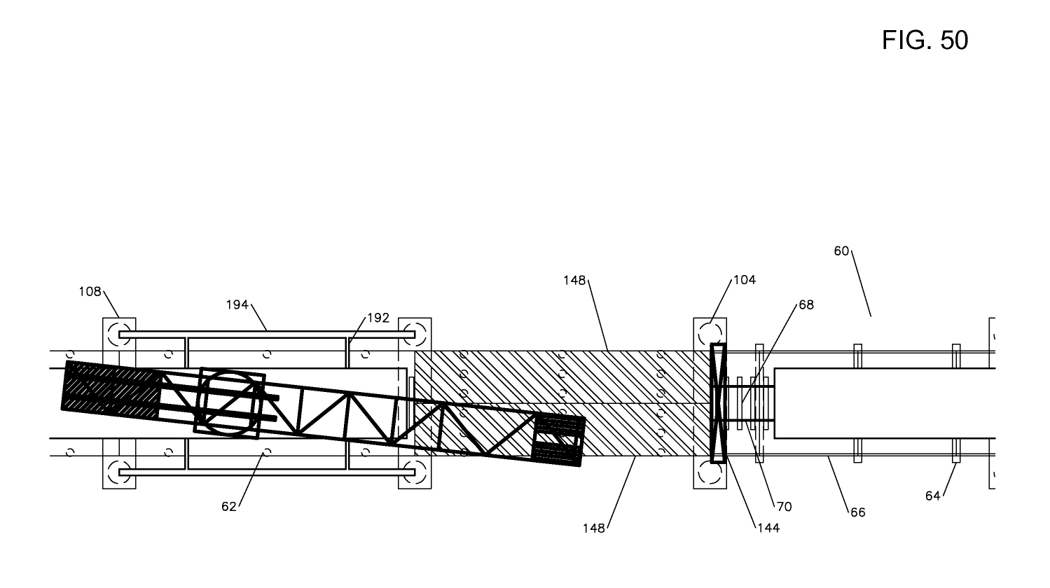

Next, as shown in FIGS. 46-50, the pile cap installation rail car 182 hoists the new span 148 from a material transport car and installs it across the newly installed pier caps 108. The new span 148 may also include a track panel with the new rails and railroad ties already installed on the span 148.

At the end of the allotted construction period, the pile cap installation rail car 182 can be relocated off the bridge and onto the staging area to permit the resumption of rail traffic.

In essence, the present invention comprises an apparatus for placing a pile to support a bridge span supporting a set of rails which includes a platform having a set of rail wheels rotatably mounted to the platform, a tower mounted to the platform and having pairs of opposed arms which are configured to support a hoisting cable and rotatably mounted with respect to the platform. The apparatus may further include outriggers slidably mounted on opposite sides along the longitudinal axis of the platform, and ground wheels rotatably mounted to the platform and capable of being oriented such that the axes of rotation are substantially parallel to the longitudinal axis of the platform. The apparatus may further include a rotating cutting blade movably mounted to the platform proximate the tower.

The present invention also comprises a method for placing piles to support a bridge span, comprising the steps of: 1) providing a vehicle which includes a platform having a set of rail wheels rotatably mounted to the platform, a tower mounted to the platform, the tower having pairs of opposed arms configured to support a hoisting cable and rotatably mounted with respect to the platform; 2) transporting the vehicle along the rails to the bridge; 3) hoisting a pair of piles on opposing arms of the tower; and 4) lowering the piles into position on opposite sides of the platform. The method may also include providing a pair of pile hammers, each supported on opposing arms of the tower, and driving the piles with the pile hammers.

In essence, the present invention also comprises a method for placing piles to support a bridge span including the steps of 1) providing a vehicle at a staging area proximate a portion of the rails, the vehicle including a platform with a set of rail wheels rotatably mounted to the platform, a set of ground wheels rotatably mounted to the platform which may be oriented such that the axes of rotation are substantially parallel to the longitudinal axis of the platform, and which are mounted to the platform with a lifting mechanism such that height of the platform above the axes of rotation may be adjusted, a tower pivotally mounted to the platform by a rotating base, the tower having two pairs of opposed arms on perpendicular axes each which may support a hoisting cable, a pair of outriggers on opposite sides of the platform slidably mounted along the longitudinal axis of the platform, a second pair of outriggers mounted on opposite sides of the platform, and a pair of positioning arms configured to secure a pile slidably mounted on the platform on an axis transverse to the longitudinal axis of the platform and proximate the vertical axis of the tower; 2) repositioning the vehicle above the rails using the set of ground wheels; 3) lowering the vehicle so that the rail wheels are supported by the rails; 4) repositioning the vehicle along the track to the bridge; 5) positioning each of the first pair outriggers on a pair of support surfaces; 6) hoisting a pair of piles on opposed arms of the tower; 7) lowering the pair of piles into position for installation; 8) securing the piles with the pile positioning arms; 9) providing a pair of pile hammers; 10) supporting each of the pile hammers by a hoisting cable on a pair of opposed arms; 11) driving the piles; 12) securing the upper portion of each pile with a hoisting cable on one of a pair of opposed arms; 13) cutting the top of the pile to the desired elevation; 14) hoisting each of the cutoff portions of the piles with a hoisting cable on a pair of opposed arms; 15) repositioning the platform so that the second pair of outriggers is positioned on a pair of driven piles, while maintaining each of the first pair of outriggers in contact with the support surfaces; 16) repositioning the first pair of outriggers to the pair of driven piles; 17) repositioning the vehicle to the rails proximate the staging area; 18) raising the vehicle above the rails proximate the staging area using the ground wheels; and 19) repositioning the vehicle to the staging area using the ground wheels.

In essence, the present invention also comprises an apparatus for placing a cap on a pair of piles to support a bridge including a platform; a set of rail wheels rotatably mounted to the platform; and a tower pivotally mounted to the upper surface of the platform by a rotating base, with an arm configured with a slidably mounted hoisting cable and a slidably mounted counterweight. The apparatus may also include ground wheels rotatably mounted to the platform which are capable of being oriented such that the axes of rotation are substantially parallel to the longitudinal axis of the platform, and mounted to the platform with a lifting mechanism such that height of the platform above the axes of rotation may be adjusted. The apparatus may also include a positioning mechanism to selectively position the counterweight along a portion of the longitudinal axis of the arm, and a control system in communication with the positioning mechanism to position the counterweight along a portion of the longitudinal axis of the arm according to the load applied to the hoisting cable and the position of the hoisting cable along the longitudinal axis of the arm.

In essence, the present invention also comprises a method for placing a cap on a pair of piles including the steps of 1) providing a vehicle at a staging area which includes a platform, a set of rail wheels rotatably mounted to the platform, and a tower pivotally mounted to the upper surface of the platform by a rotating base with an arm configured with a slidably mounted hoisting cable and a slidably mounted counterweight; 2) transporting the vehicle along the rails to the bridge; 3) securing to the hoisting cable a pair of substantially U-shaped picking frames joined by a connecting member which is selectively attachable to one of the frames; 4) supporting a pile cap on the connecting member between the picking frames; 5) positioning the pile cap on the piles; and 6) separating the connecting member from one of the frames. The method may also include a vehicle with a positioning mechanism to selectively position the counterweight along a portion of the longitudinal axis of the arm and a control system in communication with the positioning mechanism to position the counterweight along a portion of the longitudinal axis of the arm to the load applied to the hoisting cable and the position of the hoisting cable along the longitudinal axis of the arm.

In essence, the present invention also comprises a method for placing a cap on a pair of piles, including the steps of: 1) providing a cap having openings which correspond with the openings in the piles; 2) placing the cap on the piles; 3) placing a structural member in the opening of each pile such that a portion of each member extends above the pile and into the opening in the cap; and 4) placing a filler material in the openings in the piles and the cap. The method may also include the step of placing an inset in each pile, which extends across the opening and supports the member and the filler material, by suspending it from the upper surface of the pile with structural members, straps, chains or cables, or by supporting it with a bracket welded to the inner surface of the pile or a fastening device secured to the inner surface of the pile.

In essence, the present invention also comprises a vehicle for transporting longitudinal structural members including a platform with a set of rail wheels and a pair of upward extending substantially parallel sidewalls, each sidewall having a bracing member and a hingedly-mounted sidewall extension which can be supported in a horizontal orientation by the bracing member. The sidewall extensions may also include of rollers oriented with the axes of rotation substantially perpendicular to the longitudinal axis of the platform, and the vehicle may also have a lifting mechanism mounted to the platform.

In essence, the present invention also comprises a method for transporting and offloading longitudinal structural members, such as piles, including the steps of: 1) providing a vehicle having a platform, a pair of substantially parallel sidewalls extending upwards, a set of rail wheels rotatably mounted to the platform, a sidewall extension hingedly mounted to the upper portion of each sidewall and having rollers oriented such that the axes of rotation are substantially perpendicular to the longitudinal axis of the platform, and a bracing member configured to supported the sidewall extension in a horizontal orientation; 2) positioning the piles on the platform between the sidewalls and transporting the vehicle along the rails; 3) repositioning the piles to the rollers on the sidewall extensions; and 4) rolling the piles on the rollers. The vehicle may also have a lifting mechanism mounted to the platform and the method may include the step of raising the piles with the lifting mechanism to the level of the rollers on the sidewall extensions.

These examples are provided for the purposes of illustration and the present invention is not limited to them.

What is claimed is:

1. An apparatus for placing a pile to support a bridge span supporting a set of rails, the apparatus comprising:
a platform;
a set of rail wheels configured to roll on the rails, the rail wheels rotatably mounted to the platform;
a tower mounted to the platform, the tower having a first pair of opposed arms, each configured to support a hoisting cable, the arms rotatably mounted with respect to the platform.

2. The apparatus of claim 1 wherein the tower is pivotally mounted to the platform by a rotating base.

3. The apparatus of claim 1 wherein the pair of opposed arms is mounted to the tower by a rotating base.

4. The apparatus of claim 1 further comprising a pair of outriggers mounted on opposite sides of the platform.

5. The apparatus of claim 4 further comprising a second pair of outriggers mounted on opposite sides of the platform.

6. The apparatus of claim 1 wherein a pair of outriggers is slidably mounted along the longitudinal axis of the platform.

7. The apparatus of claim 1 further comprising a set of ground wheels rotatably mounted to the platform and capable of being oriented such that the axes of rotation are substantially parallel to the longitudinal axis of the platform.

8. The apparatus of claim 7 wherein the set of ground wheels is mounted to the platform with a lifting mechanism such that height of the platform above the axes of rotation may be adjusted.

9. The apparatus of claim 8 wherein the lifting mechanism comprises a cylinder which is actuated by applied hydraulic or pneumatic pressure.

10. The apparatus of claim 1 further comprising a rotating cutting blade movably mounted to the platform proximate the tower.

11. The apparatus of claim 1 wherein the tower further comprises second pair of opposed arms, each configured to support a hoisting cable, oriented on an axis perpendicular to the axis of the first pair of opposed arms.

12. The apparatus of claim 1 wherein the tower comprises a plurality of telescoping sections.

13. The apparatus of claim 1 wherein the tower is hingedly mounted to the rotating base.

14. The apparatus of claim 3 wherein the tower is hingedly mounted to the platform.

15. The apparatus of claim 1 wherein the opposed arms are hingedly mounted to the tower.

16. The apparatus of claim 15 wherein a kingpost is mounted to the upper portion of the tower, and the tower arms are secured in a horizontal position by a cable secured between the kingpost and the arm.

17. The apparatus of claim 15 wherein the tower arms are secured in a horizontal position by a bracing member secured between the tower and the arms

18. The apparatus of claim 5 wherein a pair of outriggers is configured to raise the platform.

19. An apparatus for placing a pile to support a bridge span supporting a set of rails, the apparatus comprising:
a platform;
a set of rail wheels configured to roll on the rails, the rail wheels rotatably mounted to the platform;
a tower mounted to the platform, the tower having a first pair of opposed arms, each configured to support a hoisting cable.

20. A method for placing piles to support a bridge span supporting a set of rails, the method comprising the steps of:
providing a vehicle comprising:
a platform;
a set of rail wheels configured to roll on the rails, the rail wheels rotatably mounted to the platform;
a tower mounted the platform, the tower having a first pair of opposed arms, each configured to support a hoisting cable;
transporting the vehicle along the rails to the bridge;
hoisting a pair of piles on opposing arms of the tower; and
lowering the piles into position on opposite sides of the platform.

21. The method of claim 20 further comprising the steps of:
providing a pair of pile hammers, each supported on opposing arms of the tower; and
driving the piles with the pile hammers.

22. The method of claim 21 further comprising the step of repositioning the vehicle to a staging area.

23. The method of claim 21 wherein the vehicle further comprises a first pair of outriggers mounted on opposite sides of the platform, and the method further comprises the step of positioning each outrigger over a respective one of a first pair of support surfaces.

24. The method of claim 23 wherein the first pair of outriggers are slidably mounted to the platform, and the vehicle further comprises a second pair of outriggers mounted on opposite sides of the platform, and the method further comprises the steps of:
repositioning the vehicle so that each of the second pair of outriggers is positioned on a respective one of the pair of driven piles, while maintaining each of the first pair of outriggers over a respective one of a first pair of support surfaces; and
repositioning the first pair of outriggers so that each is positioned on a respective one of the pair of driven piles.

25. The method of claim 21 wherein the vehicle further comprises a second pair of arms, and the arms are rotatably mounted with respect to the platform, and the method further comprises the step of rotating the tower to position each of the pile hammers over a respective one of the piles.

26. The method of claim 21 wherein the vehicle further comprises a set of ground wheels rotatably mounted to the platform and capable of being oriented such that the axes of rotation are substantially parallel to the longitudinal axis of the vehicle, and wherein the set of ground wheels is mounted to the platform with a lifting mechanism such that height of the platform above the axes of rotation may be adjusted, and the method further comprises the steps of:
positioning the vehicle above the rails proximate the staging area using the ground wheels; and
repositioning the vehicle to the staging area using the ground wheels.

27. The method of claim 26 further comprising the steps of:
positioning the vehicle above the rails proximate the staging area using the set of ground wheels; and
lowering the vehicle so that the rail wheels are supported by the rails.

28. A method for placing piles to support a bridge span supporting a set of rails, the method comprising the steps of:
providing a vehicle at a staging area proximate a portion of the rails, the vehicle comprising:
a platform;
a set of rail wheels configured to roll on the rails, the rail wheels rotatably mounted to the platform;
a set of ground wheels rotatably mounted to the platform and capable of being oriented such that the axes of rotation are substantially parallel to the longitudinal axis of the platform, and wherein the set of ground wheels is mounted to the platform with a lifting mechanism such that height of the platform above the axes of rotation may be adjusted;
a tower pivotally mounted to the platform by a rotating base, the tower having two pairs of opposed arms on perpendicular axes, each configured to support a hoisting cable;
a first pair of outriggers on opposite sides of the platform slidably mounted along the longitudinal axis of the platform;
a second pair of outriggers mounted on opposite sides of the platform; and
a pair of positioning arms configured to secure a pile slidably mounted on the platform on an axis transverse to the longitudinal axis of the platform and proximate the vertical axis of the tower;
repositioning the vehicle above the rails using the set of ground wheels;
lowering the vehicle so that the rail wheels are supported by the rails;
repositioning the vehicle along the track to the bridge;
positioning each of the first pair outriggers over a respective one of a first pair of support surfaces;
hoisting a pair of piles on opposed arms of the tower;
lowering the pair of piles into position for installation;
securing the piles with the pile positioning arms;
providing a pair of pile hammers;
supporting each of the pile hammers by a hoisting cable on one of a pair of opposed arms;
driving the piles;
securing the upper portion of each pile with a hoisting cable on one of a pair of opposed arms;
cutting the top of the pile to the desired elevation;
hoisting each of the cutoff portions of the piles with a hoisting cable on one of a pair of opposed arms;
repositioning the platform so that each of the second pair of outriggers is positioned on a respective one of the pair of driven piles, while maintaining each of the first pair of outriggers in contact with a respective one of a first pair of support surfaces;
repositioning the first pair of outriggers so that each is positioned on a respective one of the pair of driven piles;
repositioning the vehicle to the rails proximate the staging area;
raising the vehicle above the rails proximate the staging area using the ground wheels; and
repositioning the vehicle to the staging area using the ground wheels.

29. An apparatus for placing a cap on a pair of piles to support a bridge which supports a set of rails, the apparatus comprising:
a platform;
a set of rail wheels configured to roll on the rails, the rail wheels rotatably mounted to the platform; and
a tower pivotally mounted to the upper surface of the platform by a rotating base, the tower having an arm configured with a slidably mounted hoisting cable and a slidably mounted counterweight.

30. The apparatus of claim 29 further comprising a set of ground wheels rotatably mounted to the platform and capable of being oriented such that the axes of rotation are substantially parallel to the longitudinal axis of the platform.

31. The apparatus of claim 30 wherein the set of ground wheels is mounted to the platform with a lifting mechanism such that height of the platform above the axes of rotation may be adjusted.

32. The apparatus of claim 29 further comprising a positioning mechanism to selectively position the counterweight along a portion of the longitudinal axis of the arm.

33. The apparatus of claim 32 further comprising a control system in communication with the positioning mechanism to position the counterweight along a portion of the longitudinal axis of the arm according to the load applied to the hoisting cable.

34. The apparatus of claim 32 further comprising a control system in communication with the positioning mechanism to position the counterweight along a portion of the longitudinal axis of the arm according to the position of the hoisting cable along the longitudinal axis of the arm.

35. The apparatus of claim 32 further comprising a control system in communication with the positioning mechanism to position the counterweight along a portion of the longitudinal axis of the arm according to the load applied to the hoisting cable and the position of the hoisting cable along the longitudinal axis of the arm.

36. An apparatus for placing a cap on a pair of piles to support a bridge which supports a set of rails, the apparatus comprising:
a platform;
a set of rail wheels configured to roll on the rails, the rail wheels rotatably mounted to the platform;
a tower pivotally mounted to the upper surface of the platform by a rotating base, the tower having an arm configured with a slidably mounted hoisting cable and a slidably mounted counterweight;
a set of ground wheels rotatably mounted to the platform and capable of being oriented such that the axes of rotation are substantially parallel to the longitudinal axis of the platform, and wherein the set of ground wheels is mounted to the platform with a lifting mechanism such that height of the platform above the axes of rotation may be adjusted; and
a pair of outriggers on opposite sides of the platform.

37. A method for placing a cap on a pair of piles to support a bridge which supports a set of rails, the method comprising the steps of:
providing a vehicle at a staging area proximate a portion of the rails, the vehicle comprising:
a platform;
a set of rail wheels configured to roll on the rails, the rail wheels rotatably mounted to the platform; and
a tower pivotally mounted to the upper surface of the platform by a rotating base, the tower having an arm configured with a slidably mounted hoisting cable and a slidably mounted counterweight;
transporting the vehicle along the rails to the bridge;
securing a pair of substantially U-shaped picking frames to the hoisting cable, the frames joined by a connecting member which is selectively attachable to one of the frames;
supporting a pile cap on the connecting member between the picking frames;
positioning the pile cap on the piles; and
separating the connecting member from one of the frames.

38. The method of claim 37 further comprising the step of repositioning the vehicle to the staging area.

39. The method of claim 37 further comprising the step of positioning the counterweight a distance from the tower axis according to the distance of the hoisting cable from the tower axis.

40. The method of claim 37 wherein the vehicle further comprises a positioning mechanism to selectively position the counterweight along a portion of the longitudinal axis of the arm.

41. The method of claim 40 wherein the vehicle further comprises a control system in communication with the positioning mechanism to position the counterweight along a portion of the longitudinal axis of the arm according to the load applied to the hoisting cable.

42. The method of claim 40 wherein the vehicle further comprises a control system in communication with the positioning mechanism to position the counterweight along a portion of the longitudinal axis of the arm according to the position of the hoisting cable along the longitudinal axis of the arm.

43. The method of claim 40 wherein the vehicle further comprises a control system in communication with the positioning mechanism to position the counterweight along a portion of the longitudinal axis of the arm according to the load applied to the hoisting cable and the position of the hoisting cable along the longitudinal axis of the arm.

44. The method of claim 37 wherein the vehicle further comprises a first pair of outriggers mounted on opposite sides of the platform.

45. The method of claim 37 wherein the vehicle further comprises a set of ground wheels rotatably mounted to the platform and capable of being oriented such that the axes of rotation are substantially parallel to the longitudinal axis of the vehicle, and wherein the set of ground wheels is mounted to the platform with a lifting mechanism such that height of the platform above the axes of rotation may be adjusted, and the method further comprises the steps of:
positioning the vehicle above the rails proximate the staging area using the ground wheels; and
repositioning the vehicle to the staging area using the ground wheels.

46. The method of claim 45 further comprising the steps of:
positioning the vehicle above the rails proximate the staging area using the set of ground wheels; and
lowering the vehicle so that the rail wheels are supported by the rails.

47. A method for placing a cap on a pair of piles, the piles having an opening at the upper end, the method comprising the steps of:
providing a cap having openings which correspond with the openings in the piles;
placing the cap on the piles;
placing a structural member in the opening of each pile such that a portion of each member extends above the pile and into the opening in the cap; and
placing a filler material in the openings in the piles and the cap.

48. The method of claim 47 further comprising the step of placing an inset in each pile which extends across the opening and supports the member and the filler material.

49. The method of claim 48 wherein the inset is suspended from the upper surface of the pile.

50. The method of claim 49 wherein the inset is suspended from the upper surface of the pile by the use of a device selected from the group consisting of structural members, straps, chains or cables.

51. The method of claim 47 wherein the inset is supported by a bracket welded to the inner surface of the pile.

51. The method of claim 47 wherein the inset is supported by a fastening device secured to the inner surface of the pile.

52. The method of claim 47 wherein the filler is selected from the group consisting of grout, concrete and cement.

53. The method of claim 47 wherein the member is selected from the group consisting of H beam, pipe, and I beam.

54. A vehicle for transporting longitudinal structural members along a railway comprising:
a platform with a pair of substantially parallel sidewalls extending upwards from the platform, each sidewall having a bracing member;
a set of rail wheels configured to roll on the rails, the rail wheels rotatably mounted to the platform;
a sidewall extension hingedly mounted to the each sidewall, the sidewall extension configured to be supported in a horizontal orientation by the bracing member.

55. The vehicle of claim 54 wherein the sidewall extension comprises a plurality of rollers oriented, such that the axes of rotation are substantially perpendicular to the longitudinal axis of the platform.

56. The vehicle of claim 54 further comprising a lifting mechanism mounted to the platform.

57. A method for transporting and offloading longitudinal structural members on a set of rails comprising the steps of:
providing a vehicle comprising:
a platform with a pair of substantially parallel sidewalls extending upwards from the platform, the sidewalls having a bracing member;
a set of rail wheels configured to roll on the rails, the rail wheels rotatably mounted to the platform; and
a sidewall extension hingedly mounted to the upper portion of each sidewall, the sidewall extension comprising a plurality of rollers oriented such that the axes of rotation are substantially perpendicular to the longitudinal axis of the platform, and the sidewall extension configured to be supported in a horizontal orientation by the bracing member;
positioning the members on the platform between the sidewalls and transporting the vehicle along the rails;
repositioning the members to the rollers on the sidewall extensions; and
rolling the members on the rollers.

58. The method of claim 57 wherein the structural members are piles.

59. The method of claim 57 wherein the vehicle further comprises a lifting mechanism mounted to the platform and the method further comprises the step of raising the members with the lifting mechanism to the level of the rollers on the sidewall extensions.
